(19) United States
(12) Patent Application Publication
(10) Pub. No.: US 2026/0333071 A1
(43) Pub. Date: Oct. 22, 2026

(54) RELAY COMMUNICATION CONFIGURATION METHOD AND APPARATUS

(71) Applicant: Beijing Xiaomi Mobile Software Co., Ltd., Beijing (CN)

(72) Inventor: Xiaowei JIANG, Beijing (CN)

(21) Appl. No.: 19/113,823

(22) PCT Filed: Sep. 29, 2022
(86) PCT No.: PCT/CN2022/122771

§ 371 Date: Mar. 20, 2025

(51) Int. Cl. H04W 24/02; H04W 76/20; H04W 80/02; H04W 92/18

(52) U.S. Cl. CPC H04W 24/02; H04W 76/20; H04W 80/02; H04W 92/18

(57) ABSTRACT

A relay communication configuration method is performed by a relay terminal device, and includes: receiving first configuration information sent by a network device; determining a first mapping relationship based on the first configuration information, wherein the first mapping relationship is a mapping relationship among an identifier of a second terminal device, a bearer identifier, and an outbound PC5 radio link control (RLC) channel; and sending second configuration information to a first terminal device, wherein the second configuration information is configured to configure the first mapping relationship for the first terminal device, wherein the first terminal device communicates with the second terminal device through the relay terminal device.

### CROSS-REFERENCE TO RELATED APPLICATION

This application is a U.S. national stage application of International Application No. PCT/CN2022/122771, filed Sep. 29, 2022, the entire contents of which are incorporated herein by reference.

### FIELD

The present disclosure relates to the field of communication technologies, and in particular, to a relay communication configuration method and an apparatus.

### BACKGROUND

In related technologies, to support direct communication between terminal devices, a sidelink communication method has been introduced. Terminal device A may not directly connect to terminal device B but instead connect to terminal device B through terminal device C which acts as a relay. Here, terminal device A and terminal device B may be referred to as remote terminal devices, and terminal device C, which provides the relay function, is referred to as a relay terminal device. All terminal devices communicate via sidelink unicast communication, and this architecture is called UE-to-UE (U2U) relay. In the U2U scenario, it is an urgent problem to determine whether the relay terminal device configures the mapping relationship between the bearer identifier and the outbound PC5 radio link control (RLC) channel or the network device configures the mapping relationship of the PC5 RLC channel.

### SUMMARY

A first aspect of the present disclosure provides a relay communication configuration method, performed by a relay terminal device, including:
receiving first configuration information sent by a network device;
determining a first mapping relationship based on the first configuration information, where the first mapping relationship is a mapping relationship among an identifier of a second terminal device, a bearer identifier, and an outbound PC5 RLC channel; and
sending second configuration information to a first terminal device, where the second configuration information is configured to configure the first mapping relationship for the first terminal device, and the first terminal device communicates with the second terminal device through the relay terminal device.

A second aspect of the present disclosure provides a relay communication configuration method, performed by a network device, including:
determining a first mapping relationship corresponding to an identifier of a first terminal device, where the first mapping relationship is a mapping relationship among an identifier of a second terminal device, a bearer identifier, and an outbound PC5 RLC channel;
sending first configuration information to a relay terminal device, where the first configuration information includes the first mapping relationship.

A third aspect of the present disclosure provides a relay communication configuration method, performed by a relay terminal device, including:
determining a first mapping relationship, where the first mapping relationship is a mapping relationship among an identifier of a second terminal device, a bearer identifier, and an outbound PC5 RLC channel;
sending second configuration information to a first terminal device, where the second configuration information is configured to configure the first mapping relationship for the first terminal device.

A fourth aspect of the present disclosure provides a communication apparatus, including a processor and a memory, where the memory stores a computer program, and the processor executes the computer program stored in the memory to enable the apparatus to perform the method according to any one of the first to third aspects.

A fifth aspect of the present disclosure provides a non-transitory computer-readable storage medium having stored therein instructions that, when executed by a processor, cause the method according to any one of the first to third aspects to be implemented.

### BRIEF DESCRIPTION OF THE DRAWINGS

The following briefly introduces the accompanying drawings of the present disclosure.

FIG. 1 is a schematic diagram of a communication system architecture according to an embodiment of the present disclosure;

FIG. 2 is a flowchart of a relay communication configuration method according to an embodiment of the present disclosure;

FIG. 3 is a flowchart of another relay communication configuration method according to an embodiment of the present disclosure;

FIG. 4 is a flowchart of another relay communication configuration method according to an embodiment of the present disclosure;

FIG. 5 is a flowchart of another relay communication configuration method according to an embodiment of the present disclosure;

FIG. 6 is a flowchart of another relay communication configuration method according to an embodiment of the present disclosure;

FIG. 7 is a flowchart of another relay communication configuration method according to an embodiment of the present disclosure;

FIG. 8 is a flowchart of another relay communication configuration method according to an embodiment of the present disclosure;

FIG. 9 is a flowchart of another relay communication configuration method according to an embodiment of the present disclosure;

FIG. 10 is a flowchart of another relay communication configuration method according to an embodiment of the present disclosure;

FIG. 11 is a flowchart of another relay communication configuration method according to an embodiment of the present disclosure;

FIG. 12 is a flowchart of another relay communication configuration method according to an embodiment of the present disclosure;

FIG. 13 is a flowchart of another relay communication configuration method according to an embodiment of the present disclosure;

FIG. 14 is a flowchart of another relay communication configuration method according to an embodiment of the present disclosure;

FIG. 15 is a flowchart of another relay communication configuration method according to an embodiment of the present disclosure;

FIG. 16 is a flowchart of another relay communication configuration method according to an embodiment of the present disclosure;

FIG. 17 is a flowchart of another relay communication configuration method according to an embodiment of the present disclosure;

FIG. 18 is a flowchart of another relay communication configuration method according to an embodiment of the present disclosure;

FIG. 19 is a schematic structural diagram of a relay communication configuration apparatus according to an embodiment of the present disclosure;

FIG. 20 is a schematic structural diagram of another relay communication configuration apparatus according to an embodiment of the present disclosure;

FIG. 21 is a schematic structural diagram of another relay communication configuration apparatus according to an embodiment of the present disclosure;

FIG. 22 is a schematic structural diagram of another relay communication configuration apparatus according to an embodiment of the present disclosure; and

FIG. 23 is a schematic structural diagram of a chip according to an embodiment of the present disclosure.

### DETAILED DESCRIPTION

To better understand the configuration method of the mapping relationship between the bearer identifier and the PC5 RLC channel disclosed in the embodiments of the present disclosure, the following first describes the communication system to which the embodiments of the present disclosure are applicable.

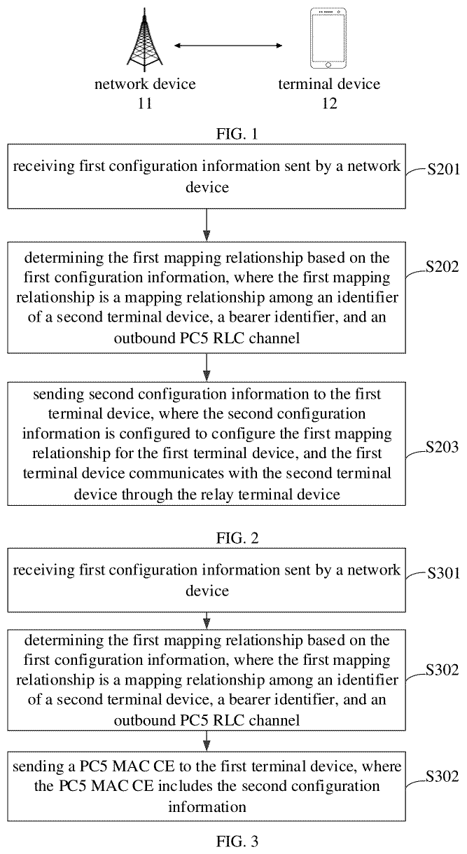

Please refer to FIG. 1, which is a schematic diagram of a communication system architecture according to an embodiment of the present disclosure. The communication system may include, but is not limited to, one network device and one terminal device. The number and form of devices shown in FIG. 1 are only for illustration and do not limit the embodiments of the present disclosure. In practical applications, the system may include two or more network devices and two or more terminal devices. The communication system shown in FIG. 1 includes one network device 11 and one terminal device 12 as an example.

It should be noted that the technical solutions of the embodiments of the present disclosure can be applied to various communication systems, such as long term evolution (LTE) systems, 5^{th}-generation (5G) mobile communication systems, 5G new radio (NR) systems, or other future new mobile communication systems.

The network device 11 in the embodiments of the present disclosure is an entity on the network side for transmitting or receiving signals. For example, the network device 101 may be an evolved NodeB (eNB), a transmission reception point (TRP), a next-generation NodeB (gNB) in an NR system, a base station in other future mobile communication systems, or an access node in a Wireless Fidelity (WiFi) system. The specific technology and device form of the network device are not limited in the embodiments of the present disclosure. The network device provided in the embodiments of the present disclosure may be composed of a central unit (CU) and a distributed unit (DU), where the CU may further be referred to as a control unit. The CU-DU structure can split the protocol layers of the network device such as a base station, with some protocol layer functions placed in the CU for centralized control, and the remaining or all protocol layer functions distributed in the DU, controlled by the CU.

The terminal device 12 in the embodiments of the present disclosure is an entity on the user side for receiving or transmitting signals, such as a mobile phone. The terminal device may further be referred to as a terminal, user equipment (UE), mobile station (MS), mobile terminal (MT), etc. The terminal device may be a car with communication functions, a smart car, a mobile phone, a wearable device, a tablet computer (Pad), a computer with wireless transceiver functions, a virtual reality (VR) terminal device, an augmented reality (AR) terminal device, a wireless terminal device in industrial control, a wireless terminal device in self-driving, a wireless terminal device in remote medical surgery, a wireless terminal device in a smart grid, a wireless terminal device in transportation safety, a wireless terminal device in a smart city, a wireless terminal device in a smart home, etc. The specific technology and device form of the terminal device are not limited in the embodiments of the present disclosure.

It should be understood that the communication system described in the embodiments of the present disclosure is to more clearly illustrate the technical solutions of the embodiments of the present disclosure and does not limit the technical solutions provided by the embodiments of the present disclosure. Those skilled in the art will understand that as the system architecture evolves and new business scenarios emerge, the technical solutions provided by the embodiments of the present disclosure are equally applicable to similar technical problems.

In related technologies, to support direct communication between terminal devices, a sidelink communication method has been introduced. Terminal device A may not directly connect to terminal device B but instead connect through terminal device C, which acts as a relay. Here, terminal device A and terminal device B may be referred to as remote terminal devices, and terminal device C, which provides the relay function, is referred to as a relay terminal device. All terminal devices communicate through sidelink unicast communication, and this architecture is called UE-to-UE (U2U) relay. In the U2U scenario, it is an urgent problem to determine whether the relay terminal device configures the mapping relationship between the bearer identifier and the outbound PC5 radio link control (RLC) channel or the network device configures the mapping relationship of the PC5 RLC channel.

The following describes in detail the relay communication configuration method and apparatus provided by the present disclosure with reference to the drawings.

A first aspect of the present disclosure provides a relay communication configuration method, performed by a relay terminal device, including:
receiving first configuration information sent by a network device;
determining a first mapping relationship based on the first configuration information, where the first mapping relationship is a mapping relationship among an identifier of a second terminal device, a bearer identifier, and an outbound PC5 RLC channel; and
sending second configuration information to a first terminal device, where the second configuration information is configured to configure the first mapping relationship for the first terminal device, and the first terminal device communicates with the second terminal device through the relay terminal device.

In an embodiment, sending the second configuration information to the first terminal device includes:
sending a PC5 media access control control element (MAC CE) to the first terminal device, where the PC5 MAC CE includes the second configuration information.

In an embodiment, sending the second configuration information to the first terminal device includes:
sending a PC5 radio resource control (RRC) signaling to the first terminal device, where the PC5 RRC signaling includes the second configuration information.

In an embodiment, the receiving the first configuration information sent by the network device includes:
receiving a dedicated RRC signaling sent by the network device;
determining the first configuration information based on the dedicated RRC signaling.

In an embodiment, the receiving the first configuration information sent by the network device includes:
receiving system information block (SIB) information sent by the network device;
determining the first configuration information based on the SIB information.

In an embodiment, the method further includes:
sending first information to the network device, where the first information includes a pair of a source layer 2 address of the first terminal device and a source layer 2 address of the second terminal device, and the first terminal device communicates with the second terminal device through the relay terminal device.

In an embodiment, sending the first information to the network device includes:
sending the first information to the network device in response to the relay terminal device being in an RRC connected state.

In an embodiment, sending the first information to the network device includes:
sending the first information to the network device in response to the relay terminal device transitioning from an RRC idle state or an RRC inactive state to an RRC connected state.

In an embodiment, sending the first information to the network device includes:
sending a sidelink UE information (SUI) signaling to the network device, where the SUI signaling includes the first information.

In an embodiment, sending the first information to the network device includes:
sending a UE assistance information (UAI) signaling to the network device, where the UAI signaling includes the first information.

In an embodiment, the SUI signaling or the UAI signaling includes one or more of:
the pair of the source layer 2 address of the first terminal device and the source layer 2 address of the second terminal device;
identifier request information of the first terminal device; or
identifier request information of the second terminal device.

In an embodiment, the identifier of the first terminal device is associated with the source layer 2 address of the first terminal device, and the identifier of the second terminal device is associated with the source layer 2 address of the second terminal device.

In an embodiment, transitioning the relay terminal device from the RRC idle state or the RRC inactive state to the RRC connected state includes:
triggering the relay terminal device to transition from the RRC idle state or the RRC inactive state to the RRC connected state in response to determining that an establishment of an end-to-end PC5 connection between the first terminal device and the second terminal device is completed.

In an embodiment, determining that the establishment of the end-to-end PC5 connection between the first terminal device and the second terminal device is completed includes:
determining that the establishment of the end-to-end PC5 connection between the first terminal device and the second terminal device is completed in response to the relay terminal device receiving a direct communication request (DCR) message transmitted by the first terminal device through a specified PC5-RLC channel and the relay terminal device receiving a direct communication acceptance (DCA) message transmitted by the second terminal device through a specified PC5-RLC channel.

A second aspect of the present disclosure provides a relay communication configuration method, performed by a network device, including:
determining a first mapping relationship corresponding to an identifier of a first terminal device, where the first mapping relationship is a mapping relationship among an identifier of a second terminal device, a bearer identifier, and an outbound PC5 RLC channel;
sending first configuration information to a relay terminal device, where the first configuration information includes the first mapping relationship.

In an embodiment, sending the first configuration information to the relay terminal device includes:
sending a dedicated RRC signaling to the relay terminal device, where the dedicated RRC signaling includes the first configuration information.

In an embodiment, sending the first configuration information to the relay terminal device includes:
sending SIB information to the relay terminal device, where the SIB information includes the first configuration information.

In an embodiment, the method further includes:
receiving first information sent by the relay terminal device, where the first information includes a pair of a source layer 2 address of the first terminal device and a source layer 2 address of the second terminal device, and the first terminal device communicates with the second terminal device through the relay terminal device.

In an embodiment, the receiving the first information sent by the relay terminal device includes:
receiving a SUI signaling sent by the relay terminal device;
determining the first information based on the SUI signaling.

In an embodiment, the receiving the first information sent by the relay terminal device includes:
receiving a UAI signaling sent by the relay terminal device;
determining the first information based on the UAI signaling.

In an embodiment, the SUI signaling or the UAI signaling includes one or more of:
the pair of the source layer 2 address of the first terminal device and the source layer 2 address of the second terminal device;
identifier request information of the first terminal device; or
identifier request information of the second terminal device.

In an embodiment, the identifier of the first terminal device is associated with the source layer 2 address of the first terminal device, and the identifier of the second terminal device is associated with the source layer 2 address of the second terminal device.

A third aspect of the present disclosure provides a relay communication configuration method, performed by a relay terminal device, including:
determining a first mapping relationship, where the first mapping relationship is a mapping relationship among an identifier of a second terminal device, a bearer identifier, and an outbound PC5 RLC channel;
sending second configuration information to a first terminal device, where the second configuration information is configured to configure the first mapping relationship for the first terminal device.

In an embodiment, sending the second configuration information to the first terminal device includes:
sending a PC5 MAC CE to the first terminal device, where the PC5 MAC CE includes the second configuration information.

In an embodiment, sending the second configuration information to the first terminal device includes:
sending a PC5 RRC signaling to the first terminal device, where the PC5 RRC signaling includes the second configuration information.

In an embodiment, determining the first mapping relationship includes:
determining the first mapping relationship in response to the relay terminal device being in a non-RRC connected state.

In an embodiment, determining the first mapping relationship includes:
determining the first mapping relationship in response to the relay terminal device being outside a coverage of a network device.

A fourth aspect of the present disclosure provides a relay communication configuration apparatus, performed by a relay terminal device, including:
a receiving module configured to receive first configuration information sent by a network device;
a processing module configured to determine a first mapping relationship based on the first configuration information, where the first mapping relationship is a mapping relationship among an identifier of a second terminal device, a bearer identifier, and an outbound PC5 RLC channel;
a sending module configured to send second configuration information to a first terminal device, where the second configuration information is configured to configure the first mapping relationship for the first terminal device, and the first terminal device communicates with the second terminal device through the relay terminal device.

In an embodiment, the sending module is further configured to:
send a PC5 MAC CE to the first terminal device, where the PC5 MAC CE includes the second configuration information.

In an embodiment, the sending module is further configured to:
send a PC5 RRC signaling to the first terminal device, where the PC5 RRC signaling includes the second configuration information.

In an embodiment, the receiving module is further configured to:
receive a dedicated RRC signaling sent by the network device;
determine the first configuration information based on the dedicated RRC signaling.

In an embodiment, the receiving module is further configured to:
receive SIB information sent by the network device;
determine the first configuration information based on the SIB information

In an embodiment, the apparatus further includes:
the sending module, further configured to send first information to the network device, where the first information includes a pair of a source layer 2 address of the first terminal device and a source layer 2 address of the second terminal device, and the first terminal device communicates with the second terminal device through the relay terminal device.

In an embodiment, the sending module is further configured to:
send the first information to the network device in response to the relay terminal device being in an RRC connected state.

In an embodiment, the sending module is further configured to:
send the first information to the network device in response to the relay terminal device transitioning from an RRC idle state or an RRC inactive state to an RRC connected state.

In an embodiment, the sending module is further configured to:
send a SUI signaling to the network device, where the SUI signaling includes the first information.

In an embodiment, the sending module is further configured to:
send a UAI signaling to the network device, where the UAI signaling includes the first information.

In an embodiment, the SUI signaling or the UAI signaling includes one or more of:
the pair of the source layer 2 address of the first terminal device and the source layer 2 address of the second terminal device;
identifier request information of the first terminal device; or
identifier request information of the second terminal device.

In an embodiment, the identifier of the first terminal device is associated with the source layer 2 address of the first terminal device, and the identifier of the second terminal device is associated with the source layer 2 address of the second terminal device.

In an embodiment, the processing module is further configured to:
trigger the relay terminal device to transition from the RRC idle state or the RRC inactive state to the RRC connected state in response to determining that an establishment of an end-to-end PC5 connection between the first terminal device and the second terminal device is completed.

In an embodiment, the processing module is further configured to:
determine that the establishment of the end-to-end PC5 connection between the first terminal device and the second terminal device is completed in response to the relay terminal device receiving a DCR message transmitted by the first terminal device through a specified PC5-RLC channel and the relay terminal device receiving a DCA message transmitted by the second terminal device through a specified PC5-RLC channel.

A fifth aspect of the present disclosure provides a relay communication configuration apparatus, performed by a network device, including:
a processing module configured to determine a first mapping relationship corresponding to an identifier of a first terminal device, where the first mapping relationship is a mapping relationship among an identifier of a second terminal device, a bearer identifier, and an outbound PC5 RLC channel;
a sending module configured to send first configuration information to a relay terminal device, where the first configuration information includes the first mapping relationship.

In an embodiment, the sending module is further configured to:
send a dedicated RRC signaling to the relay terminal device, where the dedicated RRC signaling includes the first configuration information.

In an embodiment, the sending module is further configured to:
send SIB information to the relay terminal device, where the SIB information includes the first configuration information.

In an embodiment, the apparatus further includes:
a receiving module configured to receive first information sent by the relay terminal device, where the first information includes a pair of a source layer 2 address of the first terminal device and a source layer 2 address of the second terminal device, and the first terminal device communicates with the second terminal device through the relay terminal device.

In an embodiment, the receiving module is further configured to:
receive a SUI signaling sent by the relay terminal device;
determine the first information based on the SUI signaling.

In an embodiment, the receiving module is further configured to:
receive a UAI signaling sent by the relay terminal device;
determine the first information based on the UAI signaling.

In an embodiment, the SUI signaling or the UAI signaling includes one or more of:
the pair of the source layer 2 address of the first terminal device and the source layer 2 address of the second terminal device;
identifier request information of the first terminal device; or
identifier request information of the second terminal device.

In an embodiment, the identifier of the first terminal device is associated with the source layer 2 address of the first terminal device, and the identifier of the second terminal device is associated with the source layer 2 address of the second terminal device.

A sixth aspect of the present disclosure provides a relay communication configuration apparatus, performed by a relay terminal device, including:
a processing module configured to determine a first mapping relationship, where the first mapping relationship is a mapping relationship among an identifier of a second terminal device, a bearer identifier, and an outbound PC5 RLC channel;
a sending module configured to send second configuration information to a first terminal device, where the second configuration information is configured to configure the first mapping relationship for the first terminal device.

In an embodiment, the sending module is further configured to:
send a PC5 MAC CE to the first terminal device, where the PC5 MAC CE includes the second configuration information.

In an embodiment, the sending module is further configured to:
send PC5 RRC signaling to the first terminal device, where the PC5 RRC signaling includes the second configuration information.

In an embodiment, the processing module is further configured to:
determine the first mapping relationship in response to the relay terminal device being in a non-RRC connected state.

In an embodiment, the processing module is further configured to:
determine the first mapping relationship in response to the relay terminal device being outside a coverage of a network device.

A seventh aspect of the present disclosure provides a communication apparatus, including a processor and a memory, where the memory stores a computer program, and the processor executes the computer program stored in the memory to enable the apparatus to perform the method according to any one of the first to third aspects.

An eighth aspect of the present disclosure provides a computer-readable storage medium having stored therein instructions that, when executed by a processor, cause the method according to any one of the first to third aspects to be implemented.

A ninth aspect of the present disclosure provides a relay communication configuration system, including the relay communication configuration apparatus according to the fourth aspect, the relay communication configuration apparatus according to the fifth aspect, and the relay communication configuration apparatus according to the sixth aspect.

A tenth aspect of the present disclosure provides a computer-readable storage medium for storing instructions for the communication apparatus, where the instructions, when executed, cause the communication apparatus to perform the method according to any one of the first to third aspects.

An eleventh aspect of the present disclosure provides a computer program product including a computer program, where the computer program, when executed on a computer, causes the computer to perform the method according to any one of the first to third aspects.

A twelfth aspect of the present disclosure provides a chip system, including at least one processor and an interface, configured to support a communication apparatus in implementing the functions involved in any one of the first to third aspects, such as determining or processing at least one of the data and information involved in the above methods. In one implementation, the chip system further includes a memory, where the memory is configured to store necessary computer programs and data for the communication apparatus. The chip system may be composed of a chip or may include a chip and other discrete devices.

A thirteenth aspect of the present disclosure provides a computer program, where the computer program, when executed on a computer, causes the computer to perform the method according to any one of the first to third aspects.

Please refer to FIG. 2, which is a flowchart of a relay communication configuration method according to an embodiment of the present disclosure. The method is performed by a first terminal device. As shown in FIG. 2, the method may include, but is not limited to, the following steps.
Step S201: receiving first configuration information sent by a network device.

In the present disclosure, the network device determines a first mapping relationship and sends the first configuration information to the relay terminal device. The relay terminal device receives the first configuration information sent by the network device. The first configuration information includes the first mapping relationship.
Step S202: determining the first mapping relationship based on the first configuration information, where the first mapping relationship is a mapping relationship among an identifier of a second terminal device, a bearer identifier, and an outbound PC5 RLC channel.

In the present disclosure, the first configuration information may include the first mapping relationship, where the first mapping relationship is a mapping relationship among an identifier of a second terminal device, a bearer identifier, and an outbound PC5 RLC channel. Thus, the relay terminal device can determine the first mapping relationship based on the first configuration information.

Optionally, the first mapping relationship may further be pre-configured.

In the present disclosure, the first mapping relationship may be in the form of a list, such as Table 1 below, which shows the first mapping relationship corresponding to a first terminal device.

TABLE 1

| | | |
|---|---|---|
| Second Terminal | Bearer C1 | Outbound PC5 RLC |
| Device B1 | | Channel 1 |
| Second Terminal | Bearer C2 | Outbound PC5 RLC |
| Device B1 | | Channel 2 |
| Second Terminal | Bearer C1 | Outbound PC5 RLC |
| Device B2 | | Channel 3 |
| . . . | . . . | . . . |

In Table 1, B1 and B2 represent identifiers of the second terminal devices, and C1, C2, and C3 represent bearer identifiers.

In the present disclosure, the first mapping relationship may include one or more identifiers of the second terminal devices, and one identifier of the second terminal device may correspond to one or more bearer identifiers. The present disclosure is not limited in this regard.

Optionally, the first mapping relationship may further be pre-configured.
Step S203: sending second configuration information to the first terminal device, where the second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and the first terminal device b can communicate with other terminal devices through the relay terminal device.

In the present disclosure, the first terminal device may communicate with the second terminal device through the relay terminal device. The first terminal device may be a source remote terminal device, and the second terminal device may be a target remote terminal device, or the second terminal device may be a source remote terminal device, and the first terminal device may be a target remote terminal device.

In this technical solution, the network device determines the first mapping relationship, carries the first mapping relationship in the first configuration information, and sends the first configuration information to the relay terminal device. After receiving the first configuration information, the relay terminal device configures the first mapping relationship for the first terminal device. Thus, the network device completes the determination of the first mapping relationship and sends the first mapping relationship to the relay terminal device, and the relay terminal device completes the configuration of the first mapping relationship for the first terminal device.

The present disclosure provides another relay communication configuration method. FIG. 3 is a flowchart of another relay communication configuration method according to an embodiment of the present disclosure. The method may be applied to a relay terminal device and may be performed independently or in combination with any of the embodiments or implementations of the present disclosure, or in combination with any technical solution in the related art.

As shown in FIG. 3, the relay communication configuration method may include the following steps.
Step S301: receiving first configuration information sent by a network device.

In the present disclosure, the network device determines a first mapping relationship and sends the first configuration information to the relay terminal device. The relay terminal device receives the first configuration information sent by the network device. The first configuration information includes the first mapping relationship.
Step S302: determining the first mapping relationship based on the first configuration information, where the first mapping relationship is a mapping relationship among an identifier of a second terminal device, a bearer identifier, and an outbound PC5 RLC channel.
Step S303: sending a PC5 MAC CE to the first terminal device, where the PC5 MAC CE includes the second configuration information. The second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and the first terminal device b can communicate with other terminal devices through the relay terminal device.

In the present disclosure, the relay terminal device may send a PC5 media access control control element (MAC CE) to the first terminal device, where the PC5 MAC CE includes the second configuration information.

In this technical solution, the network device determines the first mapping relationship, carries it in the first configuration information, and sends the first configuration information to the relay terminal device. After receiving the first configuration information, the relay terminal device sends the second configuration information included in the PC5 MAC CE to the first terminal device, where the second configuration information includes the first mapping relationship. Thus, the network device completes the determination of the first mapping relationship and sends it to the relay terminal device, and the relay terminal device completes the configuration of the first mapping relationship for the first terminal device.

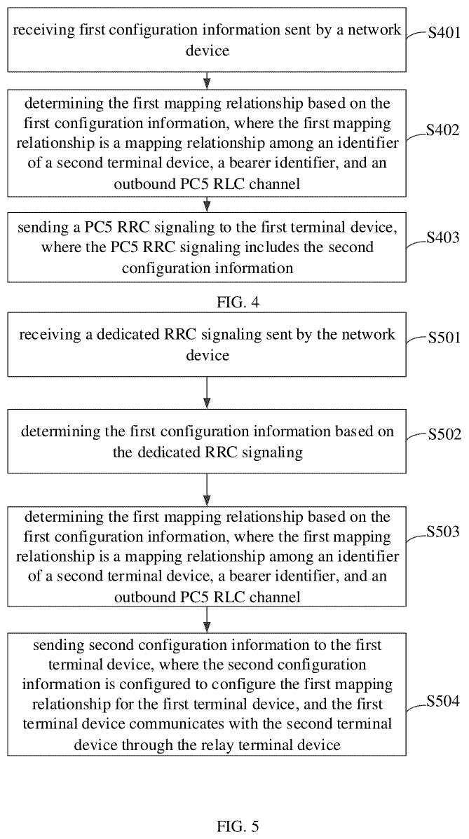

The present disclosure provides another relay communication configuration method. FIG. 4 is a flowchart of another relay communication configuration method according to an embodiment of the present disclosure. The method may be applied to a relay terminal device and may be performed independently or in combination with any of the embodiments or implementations of the present disclosure, or in combination with any technical solution in the related technologies.

As shown in FIG. 4, the relay communication configuration method may include the following steps.
Step S401: receiving first configuration information sent by a network device.

In the present disclosure, the network device determines a first mapping relationship and sends the first configuration information to the relay terminal device. The relay terminal device receives the first configuration information sent by the network device. The first configuration information includes the first mapping relationship.
Step S402: determining the first mapping relationship based on the first configuration information, where the first mapping relationship is a mapping relationship among an identifier of a second terminal device, a bearer identifier, and an outbound PC5 RLC channel.
Step S403: sending a PC5 RRC signaling to the first terminal device, where the PC5 RRC signaling includes the second configuration information. The second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and the first terminal device b can communicate with other terminal devices through the relay terminal device.

In the present disclosure, the relay terminal device may send PC5 radio resource control (RRC) signaling to the first terminal device, where the PC5 RRC signaling includes the second configuration information. The PC5 RRC signaling may be an RRCReconfigurationSidelink signaling or other PC5 RRC signaling, which is not limited in the present disclosure. That is, the relay terminal device may configure the first mapping relationship for the first terminal device through PC5 RRC signaling.

In the present disclosure, the first terminal device may further receive PC5 RRC signaling sent by the relay terminal device based on the PC5 interface, where the PC5 RRC signaling includes the second configuration information. Then, the first terminal device may determine the first configuration information based on the PC5 RRC signaling. The PC5 RRC signaling may be an RRCReconfigurationSidelink signaling or other PC5 RRC signaling, which is not limited in the present disclosure.

In this technical solution, the network device determines the first mapping relationship, carries the first mapping relationship in the first configuration information, and sends the first configuration information to the relay terminal device. After receiving the first configuration information, the relay terminal device sends the second configuration information included in the PC5 RRC signaling to the first terminal device, where the second configuration information includes the first mapping relationship. Thus, the network device completes the determination of the first mapping relationship and sends the first mapping relationship to the relay terminal device, and the relay terminal device completes the configuration of the first mapping relationship for the first terminal device.

The present disclosure provides another relay communication configuration method. FIG. 5 is a flowchart of another relay communication configuration method according to an embodiment of the present disclosure. The method may be applied to a relay terminal device and may be performed independently or in combination with any of the embodiments or implementations of the present disclosure, or in combination with any technical solution in the related art.

As shown in FIG. 5, the relay communication configuration method may include the following steps.
Step S501: receiving a dedicated RRC signaling sent by the network device.

In the present disclosure, if the first terminal device is in an RRC connected state, the network device may send dedicated RRC signaling to the first terminal device, where the dedicated RRC signaling includes the first configuration information.

That is, the network device may configure the mapping relationship among the identifier of the second terminal device, the bearer identifier, and the outbound PC5 RLC channel for the first terminal device through dedicated RRC signaling.
Step S502: determining the first configuration information based on the dedicated RRC signaling.

The dedicated RRC signaling is parsed to determine the included first configuration information. The parsing method is not limited in the present disclosure.
Step S503: determining the first mapping relationship based on the first configuration information, where the first mapping relationship is a mapping relationship among an identifier of a second terminal device, a bearer identifier, and an outbound PC5 RLC channel.

In the present disclosure, the first configuration information may include the first mapping relationship, where the first mapping relationship is a mapping relationship among an identifier of a second terminal device, a bearer identifier, and an outbound PC5 RLC channel. Thus, the relay terminal device can determine the first mapping relationship based on the first configuration information.

Optionally, the first mapping relationship may further be pre-configured.

In the present disclosure, the first mapping relationship may include one or more identifiers of the second terminal device, and one identifier of the second terminal device may correspond to one or more bearer identifiers. The present disclosure does not limit this.

Optionally, the first mapping relationship may further be pre-configured.
Step S504: sending second configuration information to the first terminal device, where the second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and the first terminal device b can communicate with other terminal devices through the relay terminal device.

In this technical solution, the network device determines the first mapping relationship, carries it in the first configuration information, and sends the first configuration information to the relay terminal device through dedicated RRC signaling. After receiving the dedicated RRC signaling, the relay terminal device determines the first mapping relationship and sends the second configuration information to the first terminal device, where the second configuration information includes the first mapping relationship. Thus, the network device completes the determination of the first mapping relationship and sends it to the relay terminal device, and the relay terminal device completes the configuration of the first mapping relationship for the first terminal device.

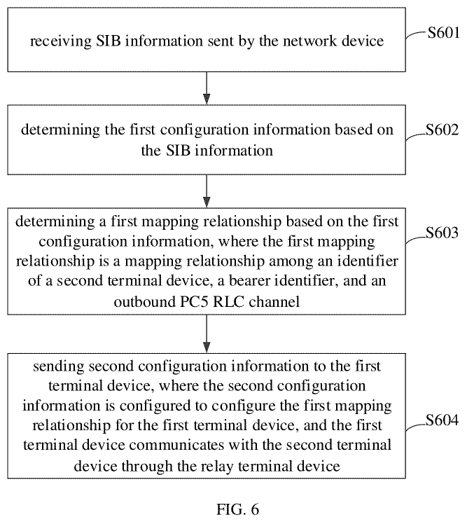

The present disclosure provides another relay communication configuration method. FIG. 6 is a flowchart of another relay communication configuration method according to an embodiment of the present disclosure. The method may be applied to a relay terminal device and may be performed independently or in combination with any of the embodiments or implementations of the present disclosure, or in combination with any technical solution in the related art.

As shown in FIG. 6, the relay communication configuration method may include the following steps.
Step S601: receiving system information block (SIB) information sent by the network device.
Step S602: determining the first configuration information based on the SIB information.

As an example, when the relay terminal device is in the RRC IDLE/INACTIVE state, the relay terminal device may receive the first configuration information sent by the network device through system messages. As another example, when the relay terminal device is in the RRC connected state, the relay terminal device may receive the first configuration information sent by the network device through system messages or dedicated RRC signaling. For instance, if the relay terminal is in the RRC connected state and the protocol standard configures dedicated RRC signaling, the relay terminal device may receive the first configuration information sent by the network device through dedicated RRC signaling. Alternatively, if the protocol standard does not configure dedicated RRC signaling and the terminal is in the RRC connected state, the terminal device may receive, through system messages, the first configuration information sent by the network device.
Step S603: determining a first mapping relationship based on the first configuration information, where the first mapping relationship is a mapping relationship among an identifier of a second terminal device, a bearer identifier, and an outbound PC5 RLC channel.

In the present disclosure, the first configuration information may include the first mapping relationship, where the first mapping relationship may be a mapping relationship among an identifier of a second terminal device, a bearer identifier, and an outbound PC5 RLC channel. Thus, the relay terminal device may determine the first mapping relationship based on the first configuration information.

Optionally, the first mapping relationship may further be pre-configured.

In the present disclosure, the identifier of the second terminal device in the first mapping relationship may be one or multiple, and one identifier of the second terminal device may correspond to one or more bearer identifiers, which is not limited in the present disclosure.

Optionally, the first mapping relationship may further be pre-configured.
Step S604: sending second configuration information to the first terminal device, where the second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and b can communicate with other terminal devices through the relay terminal device.

In this technical solution, the network device determines the first mapping relationship, carries it in the first configuration information, and sends the SIB information including the first configuration information to the relay terminal device. The relay terminal device receives and determines the first mapping relationship based on the SIB information, and then sends the second configuration information to the first terminal device, where the second configuration information includes the first mapping relationship. Thus, the network device completes the determination of the first mapping relationship and sends it to the relay terminal device, and the relay terminal device completes the configuration of the first mapping relationship for the first terminal device.

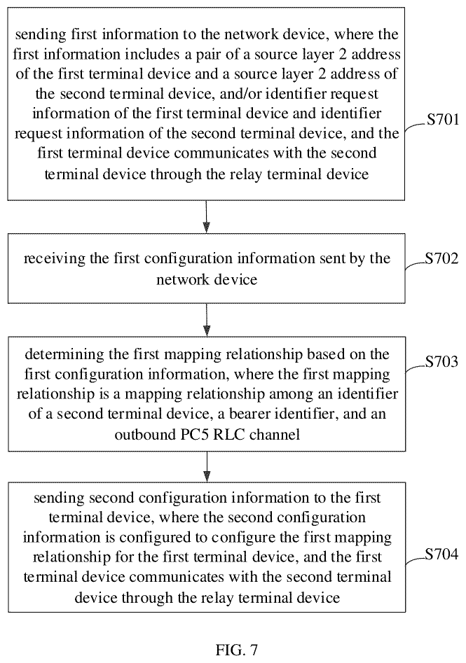

This disclosure provides another relay communication configuration method. FIG. 7 is a schematic flowchart of another relay communication configuration method provided by an embodiment of this disclosure, which may be applied to a relay terminal device. This relay communication configuration method may be executed independently, or in combination with any embodiment or implementation in the present disclosure, or in combination with any technical solution in related technologies.

As shown in FIG. 7, the relay communication configuration method may include the following steps.
Step S701: sending first information to the network device, where the first information includes a pair of a source layer 2 address of the first terminal device and a source layer 2 address of the second terminal device, and/or identifier request information of the first terminal device (local ID request) and identifier request information of the second terminal device (local ID request), and the first terminal device communicates with the second terminal device through the relay terminal device.

The relay terminal device reports the pair of the source layer 2 address of the first terminal device and the source layer 2 address of the second terminal device, which are relayed through the relay terminal device, to the network device. The network device determines the first mapping relationship based on the source layer 2 address of the first terminal device and the source layer 2 address of the second terminal device, and sends the first configuration information to the relay terminal device, where the first configuration information includes the first mapping relationship.

In the present disclosure, the first terminal device may communicate with the second terminal device through the relay terminal device. The first terminal device may be a source remote terminal device, and the second terminal device may be a target remote terminal device, or the second terminal device may be a source remote terminal device, and the first terminal device may be a target remote terminal device.
Step S702: receiving the first configuration information sent by the network device.

The relay terminal device receives the first configuration information sent by the network device, where the first configuration information includes the first mapping relationship.
Step S703: determining the first mapping relationship based on the first configuration information, where the first mapping relationship is a mapping relationship among an identifier of a second terminal device, a bearer identifier, and an outbound PC5 RLC channel.

Here, the first configuration information may be configured to configure the first mapping relationship for the first terminal device. The explanation of the first mapping relationship can be referred to the above embodiment, and thus will not be repeated here.

In the present disclosure, the identifier of the second terminal device in the first mapping relationship may be one or multiple, and one identifier of the second terminal device may correspond to one or more bearer identifiers, which is not limited in the present disclosure.

Optionally, the first mapping relationship may further be pre-configured.
Step S704: sending second configuration information to the first terminal device, where the second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and the second configuration information corresponding to the first terminal device b, so as to configure the first mapping relationship for the first terminal device. Then, the relay terminal device may send the corresponding first mapping relationship to the first terminal device a and send the corresponding first mapping relationship to the first terminal device b. Here, both the first terminal device a and b can communicate with other terminal devices through the relay terminal device.

In this technical solution, the relay terminal device sends the first information, which includes the pair of the source layer 2 address of the first terminal device and the source layer 2 address of the second terminal device, to the network device. The network device determines the first mapping relationship based on the first information, carries it in the first configuration information, and sends the first configuration information to the relay terminal device. After receiving the first configuration information, the relay terminal device determines the first mapping relationship and sends the second configuration information to the first terminal device, where the second configuration information includes the first mapping relationship. Thus, the network device completes the determination of the first mapping relationship and sends it to the relay terminal device, and the relay terminal device completes the configuration of the first mapping relationship for the first terminal device.

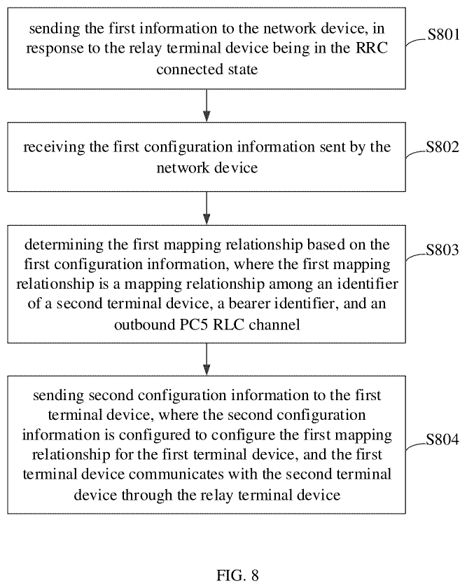

This disclosure provides another relay communication configuration method. FIG. 8 is a schematic flowchart of another relay communication configuration method provided by an embodiment of this disclosure, which may be applied to a relay terminal device. This relay communication configuration method may be executed independently, or in combination with any embodiment or implementation in the present disclosure, or in combination with any technical solution in related technologies.

As shown in FIG. 8, the relay communication configuration method may include the following steps.
Step S801: sending the first information to the network device, in response to the relay terminal device being in the RRC connected state.

The first information includes a pair of a source layer 2 address of the first terminal device and a source layer 2 address of the second terminal device, and/or identifier request information of the first terminal device, and/or identifier request information of the second terminal device, and the first terminal device communicates with the second terminal device through the relay terminal device.

When the relay terminal device determines that the establishment of the end-to-end PC5-RRC connection between the first terminal device and the second terminal device is completed, and the relay terminal device is in the RRC non-connected state, the relay terminal device triggers itself to enter the RRC connected state, and then sends a SUI signaling to the network device, where the SUI signaling includes the first information, which includes the pair of the source layer 2 address of the first terminal device and the source layer 2 address of the second terminal device, and/or identifier request information of the first terminal device, and/or identifier request information of the second terminal device.

In the present disclosure, the RRC non-connected state of the relay terminal device includes but is not limited to the RRC idle (IDLE) state or the inactive (INACTIVE) state.

The relay terminal device in the RRC connected state reports the pair of the source layer 2 address of the first terminal device and the source layer 2 address of the second terminal device, which are relayed through it, and/or the identifier request information of the first terminal device and/or the identifier request information of the second terminal device to the network device. The network device determines the first mapping relationship based on the source layer 2 address of the first terminal device and the source layer 2 address of the second terminal device, and sends the first configuration information to the relay terminal device.

In the present disclosure, the first terminal device may communicate with the second terminal device through the relay terminal device. The first terminal device may be a source remote terminal device, and the second terminal device may be a target remote terminal device, or the second terminal device may be a source remote terminal device, and the first terminal device may be a target remote terminal device.
Step S802: receiving the first configuration information sent by the network device.

The relay terminal device receives the first configuration information sent by the network device, where the first configuration information includes the first mapping relationship.
Step S803: determining the first mapping relationship based on the first configuration information, where the first mapping relationship is a mapping relationship among an identifier of a second terminal device, a bearer identifier, and an outbound PC5 RLC channel.

Here, the first configuration information may be configured to configure the first mapping relationship for the first terminal device. The explanation of the first mapping relationship can be referred to the above embodiment, and thus will not be repeated here.
Step S804: sending second configuration information to the first terminal device, where the second configuration information is configured to configure the first mapping relationship for the first terminal device, and the first terminal device communicates with the second terminal device through the relay terminal device.

Optionally, if there are multiple first terminal devices, the relay terminal device may configure the corresponding first mapping relationship for each first terminal device.

In this technical solution, the relay terminal device sends the first information, which includes the pair of the source layer 2 address of the first terminal device and the source layer 2 address of the second terminal device, and/or the identifier request information of the first terminal device, and/or the identifier request information of the second terminal device, to the network device. The network device determines the first mapping relationship based on the first information, carries it in the first configuration information, and sends the first configuration information to the relay terminal device in the RRC connected state. After receiving the first configuration information, the relay terminal device in the RRC connected state determines the first mapping relationship and sends the second configuration information to the first terminal device, where the second configuration information includes the first mapping relationship. Thus, the network device completes the determination of the first mapping relationship and sends the first mapping relationship to the relay terminal device in the RRC connected state, and the relay terminal device in the RRC connected state completes the configuration of the first mapping relationship for the first terminal device.

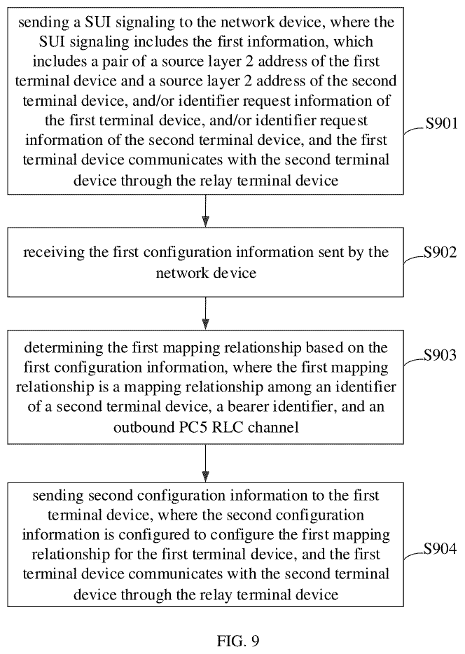

This disclosure provides another relay communication configuration method. FIG. 9 is a schematic flowchart of another relay communication configuration method provided by an embodiment of this disclosure, which may be applied to a relay terminal device. This relay communication configuration method may be executed independently, or in combination with any embodiment or implementation in the present disclosure, or in combination with any technical solution in related technologies.

As shown in FIG. 9, the relay communication configuration method may include the following steps.
Step S901: sending a SUI signaling to the network device, where the SUI signaling includes the first information, which includes a pair of a source layer 2 address of the first terminal device and a source layer 2 address of the second terminal device, and/or identifier request information of the first terminal device, and/or identifier request information of the second terminal device, and the first terminal device communicates with the second terminal device through the relay terminal device.

The sidelink UE information (SUI) signaling is configured to send the first information between the relay terminal device and the network device. The relay terminal device may report the first information through the SUI signaling to assist the network device in configuring the first mapping relationship. The SUI signaling includes one or more of the following information: a pair of the source layer 2 address of the first terminal device and the source layer 2 address of the second terminal device, and/or identifier request information of the first terminal device, and/or identifier request information of the second terminal device, where the identifier of the first terminal device is associated with the source layer 2 address of the first terminal device, and the identifier of the second terminal device is associated with the source layer 2 address of the second terminal device. The content included in the SUI signaling is not limited in the present disclosure.

The relay terminal device reports the first information included in the SUI signaling to the network device, and the network device determines the first mapping relationship based on the pair of the source layer 2 address of the first terminal device and the source layer 2 address of the second terminal device included in the SUI signaling, and sends the first configuration information to the relay terminal device.
Step S902: receiving the first configuration information sent by the network device.

After sending the first information to the network device based on the SUI signaling, the relay terminal device receives the first configuration information sent by the network device, where the first configuration information includes the first mapping relationship.
Step S903: determining the first mapping relationship based on the first configuration information, where the first mapping relationship is a mapping relationship among an identifier of a second terminal device, a bearer identifier, and an outbound PC5 RLC channel.

In the present disclosure, the first configuration information may include the first mapping relationship, where the first mapping relationship may be a mapping relationship among an identifier of a second terminal device, a bearer identifier, and an outbound PC5 RLC channel. Thus, the relay terminal device may determine the first mapping relationship based on the first configuration information.

In the present disclosure, the identifier of the second terminal device in the first mapping relationship may be one or multiple, and one identifier of the second terminal device may correspond to one or more bearer identifiers, which is not limited in the present disclosure.
Step S904: sending second configuration information to the first terminal device, where the second configuration information is configured to configure the first mapping relationship for the first terminal device, and the first terminal device communicates with the second terminal device through the relay terminal device.

Here, the second configuration information may be configured to configure the first mapping relationship for the first terminal device. The explanation of the first mapping relationship can be referred to the above embodiment, and thus will not be repeated here.

In this technical solution, the relay terminal device sends the first information, which includes the pair of the source layer 2 address of the first terminal device and the source layer 2 address of the second terminal device, and/or the identifier request information of the first terminal device, and/or the identifier request information of the second terminal device, to the network device through the SUI signaling. The network device determines the first mapping relationship based on the first information, carries it in the first configuration information, and sends the first configuration information to the relay terminal device. After receiving the first configuration information, the relay terminal device determines the first mapping relationship and sends the second configuration information to the first terminal device, where the second configuration information includes the first mapping relationship. Thus, the network device completes the determination of the first mapping relationship and sends he first mapping relationship to the relay terminal device, and the relay terminal device completes the configuration of the first mapping relationship for the first terminal device.

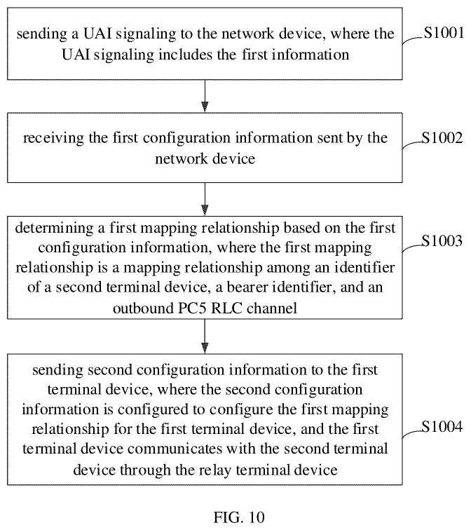

This disclosure provides another relay communication configuration method. FIG. 10 is a schematic flowchart of another relay communication configuration method provided by an embodiment of this disclosure, which may be applied to a relay terminal device. This relay communication configuration method may be executed independently, or in combination with any embodiment or implementation in the present disclosure, or in combination with any technical solution in related technologies.

As shown in FIG. 10, the relay communication configuration method may include the following steps.
Step S1001: sending a UE assistance information (UAI) signaling to the network device, where the UAI signaling includes the first information.

The UAI signaling includes the first information, which includes a pair of a source layer 2 address of the first terminal device and a source layer 2 address of the second terminal device, and/or identifier request information of the first terminal device, and/or identifier request information of the second terminal device, and the first terminal device communicates with the second terminal device through the relay terminal device.

The UAI signaling is auxiliary information (first information) sent between the relay terminal device and the network device. The relay terminal device may report the first information through the UAI signaling to assist the network device in configuring the first mapping relationship. The UAI signaling includes one or more of the following information: a pair of the source layer 2 address of the first terminal device and the source layer 2 address of the second terminal device, and/or identifier request information of the first terminal device, and/or identifier request information of the second terminal device, where the identifier of the first terminal device is associated with the source layer 2 address of the first terminal device, and the identifier of the second terminal device is associated with the source layer 2 address of the second terminal device. The content included in the UAI signaling is not limited in the present disclosure.

The relay terminal device reports the first information included in the UAI signaling to the network device, and the network device determines the first mapping relationship based on the pair of the source layer 2 address of the first terminal device and the source layer 2 address of the second terminal device included in the UAI signaling, and sends the first configuration information to the relay terminal device.
Step S1002: receiving the first configuration information sent by the network device.

After sending the first information to the network device based on the SUI signaling, the relay terminal device receives the first configuration information sent by the network device, where the first configuration information includes the first mapping relationship.
Step S1003: determining a first mapping relationship based on the first configuration information, where the first mapping relationship is a mapping relationship among an identifier of a second terminal device, a bearer identifier, and an outbound PC5 radio link control (RLC) channel.

In the present disclosure, the first configuration information may include the first mapping relationship, where the first mapping relationship may be a mapping relationship among the identifier of the second terminal device, the bearer identifier, and the outbound PC5 RLC channel. Thus, the relay terminal device may determine the first mapping relationship based on the first configuration information.

In the present disclosure, the first mapping relationship may include one or multiple identifiers of the second terminal devices, and one identifier of the second terminal device may correspond to one or multiple bearer identifiers, which is not limited herein.

Optionally, the first mapping relationship may further be pre-configured.
Step S1004: sending second configuration information to the first terminal device, where the second configuration information is configured to configure the first mapping relationship for the first terminal device, and the first terminal device communicates with the second terminal device through the relay terminal device.

The second configuration information may be configured to configure the first mapping relationship for the first terminal device. For explanations of the first mapping relationship, reference may be made to the above embodiments, which are not repeated here.

In this technical solution, the relay terminal device sends first information to the network device via UE assistance information (UAI) signaling. The first information includes a pair of a source layer 2 address of the first terminal device and a source layer 2 address of the second terminal device, and/or identifier request information of the first terminal device, and/or identifier request information of the second terminal device. The network device determines the first mapping relationship based on the first information, includes the first mapping relationship in the first configuration information, and sends the first configuration information to the relay terminal device. After receiving the first configuration information, the relay terminal device determines the first mapping relationship and sends the second configuration information to the first terminal device, where the second configuration information includes the first mapping relationship. Thus, the network device completes the determination of the first mapping relationship based on the first information sent by the relay terminal device and sends it to the relay terminal device, which then configures the first mapping relationship for the first terminal device.

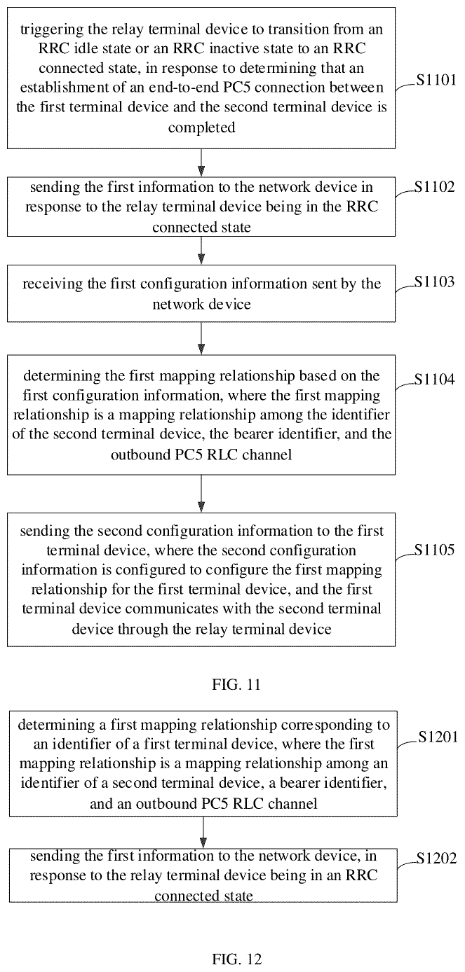

The present disclosure provides another relay communication configuration method. FIG. 11 is a schematic flowchart of another relay communication configuration method according to an embodiment of the present disclosure, which may be applied to a relay terminal device. This method may be executed independently, combined with any embodiment or implementation in the present disclosure, or combined with any technical solution in related art.

As shown in FIG. 11, the relay communication configuration method may include the following steps.
Step S1101: triggering the relay terminal device to transition from an RRC idle (IDLE) state or an RRC inactive (INACTIVE) state to an RRC connected state, in response to determining that an establishment of an end-to-end PC5 connection between the first terminal device and the second terminal device is completed.

The relay terminal device determines that the establishment of the end-to-end PC5 connection between the first terminal device and the second terminal device is completed, in response to receiving a direct communication request (DCR) message which is transmitted by the first terminal device through a specified PC5-RLC channel and receiving a direct communication acceptance (DCA) message which is transmitted by the second terminal device through a specified PC5-RLC channel.

For example, the relay terminal device forwards the DCR message sent by the first terminal device to the second terminal device and forwards the DCA message sent by the second terminal device to the first terminal device. The DCR and DCA messages are transmitted through the specified PC5-RLC channel. Upon receiving messages transmitted through the specified PC5-RLC channel, the relay terminal device confirms that the end-to-end PC5 connection between the first terminal device and the second terminal device, relayed through it, is established. This triggers the relay terminal device in the RRC IDLE/INACTIVE state to enter the RRC connected state.
Step S1102: sending the first information to the network device in response to the relay terminal device being in the RRC connected state.

The first information includes a pair of the source layer 2 address of the first terminal device and the source layer 2 address of the second terminal device, and/or identifier request information of the first terminal device, and/or identifier request information of the second terminal device, where the first terminal device communicates with the second terminal device through the relay terminal device.

The relay terminal device in the RRC connected state reports the pair of the source layer 2 address of the first terminal device and the source layer 2 address of the second terminal device to the network device. The network device determines the first mapping relationship based on the source layer 2 addresses and sends the first configuration information to the relay terminal device.

In the present disclosure, the first terminal device may communicate with the second terminal device through the relay terminal device. The first terminal device may be a source remote terminal device and the second terminal device may be a target remote terminal device, or the second terminal device may be a source remote terminal device and the first terminal device may be a target remote terminal device.
Step S1103: receiving the first configuration information sent by the network device.

The relay terminal device receives the first configuration information sent by the network device, where the first configuration information includes the first mapping relationship.
Step S1104: determining the first mapping relationship based on the first configuration information, where the first mapping relationship is a mapping relationship among the identifier of the second terminal device, the bearer identifier, and the outbound PC5 RLC channel.

In the present disclosure, the first configuration information may include the first mapping relationship, where the first mapping relationship may be a mapping relationship among the identifier of the second terminal device, the bearer identifier, and the outbound PC5 RLC channel. Thus, the relay terminal device may determine the first mapping relationship based on the first configuration information.

In the present disclosure, the first mapping relationship may include one or multiple identifiers of the second terminal device, and one identifier of the second terminal device may correspond to one or multiple bearer identifiers, which is not limited herein.

Optionally, the first mapping relationship may further be pre-configured.
Step S1105: sending the second configuration information to the first terminal device, where the second configuration information is configured to configure the first mapping relationship for the first terminal device, and the first terminal device communicates with the second terminal device through the relay terminal device.

Here, the second configuration information may be configured to configure the first mapping relationship for the first terminal device. The explanation of the first mapping relationship can be referred to the above embodiment, and thus will not be repeated here.

In this technical solution, the relay terminal device sends the first information, including the pair of the source layer 2 address of the first terminal device and the source layer 2 address of the second terminal device, and/or identifier request information of the first terminal device, and/or identifier request information of the second terminal device, to the network device. The network device determines the first mapping relationship based on the first information, includes it in the first configuration information, and sends the first configuration information to the relay terminal device in the RRC connected state. The relay terminal device in the RRC connected state determines the first mapping relationship after receiving the first configuration information and sends the second configuration information to the first terminal device, where the second configuration information includes the first mapping relationship. Thus, the network device completes the determination of the first mapping relationship based on the first information sent by the relay terminal device and sends it to the relay terminal device in the RRC connected state, which then configures the first mapping relationship for the first terminal device.

The present disclosure provides another relay communication configuration method. FIG. 12 is a schematic flowchart of another relay communication configuration method according to an embodiment of the present disclosure, which may be applied to a network device. This method may be executed independently, combined with any embodiment or implementation in the present disclosure, or combined with any technical solution in related art.

As shown in FIG. 12, the relay communication configuration method may include the following steps.
Step S1201: determining a first mapping relationship corresponding to an identifier of a first terminal device, where the first mapping relationship is a mapping relationship among an identifier of a second terminal device, a bearer identifier, and an outbound PC5 RLC channel.

In the present disclosure, the first mapping relationship may be in a list format. For example, Table 1 below shows the first mapping relationship corresponding to a first terminal device.

TABLE 1

| | | |
|---|---|---|
| Second Terminal | Bearer C1 | Outbound PC5 RLC |
| Device B1 | | Channel 1 |
| Second Terminal | Bearer C2 | Outbound PC5 RLC |
| Device B1 | | Channel 2 |
| Second Terminal | Bearer C1 | Outbound PC5 RLC |
| Device B2 | | Channel 3 |
| . . . | . . . | . . . |

In Table 1, B1 and B2 represent identifiers of the second terminal devices, and C1, C2, and C3 represent bearer identifiers.

In the present disclosure, the first mapping relationship may include one or multiple identifiers of the second terminal device, and one identifier of the second terminal device may correspond to one or multiple bearer identifiers, which is not limited herein.

Optionally, the first mapping relationship may further be pre-configured.
Step S1202: sending first configuration information to the relay terminal device, where the first configuration information includes the first mapping relationship.

In this technical solution, the network device determines the first mapping relationship, includes it in the first configuration information, and sends the first configuration information to the relay terminal device. The relay terminal device, upon receiving the first configuration information, determines the first mapping relationship and sends the second configuration information to the first terminal device, where the second configuration information includes the first mapping relationship. Thus, the network device completes the determination of the first mapping relationship and sends it to the relay terminal device, which then configures the first mapping relationship for the first terminal device.

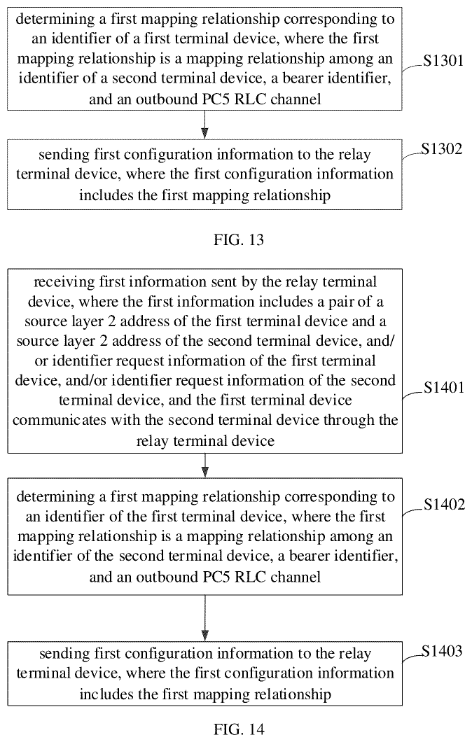

The present disclosure provides another relay communication configuration method. FIG. 13 is a schematic flowchart of another relay communication configuration method according to an embodiment of the present disclosure, which may be applied to a network device. This method may be executed independently, combined with any embodiment or implementation in the present disclosure, or combined with any technical solution in related art.

As shown in FIG. 13, the relay communication configuration method may include the following steps.
Step S1301: determining a first mapping relationship corresponding to an identifier of a first terminal device, where the first mapping relationship is a mapping relationship among an identifier of a second terminal device, a bearer identifier, and an outbound PC5 RLC channel.

In the present disclosure, the first mapping relationship may include one or multiple identifiers of the second terminal device, and one identifier of the second terminal device may correspond to one or multiple bearer identifiers, which is not limited herein.

Optionally, the first mapping relationship may further be pre-configured.

In the present disclosure, the first terminal device may communicate with the second terminal device through the relay terminal device. The first terminal device may be a source remote terminal device, and the second terminal device may be a target remote terminal device, or vice versa.
Step S1302: sending first configuration information to the relay terminal device, where the first configuration information includes the first mapping relationship.

In the present disclosure, if the relay terminal device is in the RRC connected state, the network device may send dedicated RRC signaling to the relay terminal device, where the dedicated RRC signaling includes the first configuration information. Alternatively, the network device may send system information block (SIB) information to the relay terminal device, where the SIB information includes the first configuration information. That is, the network device may configure the mapping relationship among the identifier of the second terminal device, the bearer identifier, and the outbound PC5 RLC channel through dedicated RRC signaling or SIB information.

Optionally, if there are multiple relay terminal devices, the network device may configure the corresponding first mapping relationship for each relay terminal device.

In this technical solution, the network device determines the first mapping relationship, includes it in RRC signaling or SIB information, and sends the RRC signaling or SIB information to the relay terminal device. The relay terminal device obtains the first configuration information upon receiving the RRC signaling or SIB information, determines the first mapping relationship, and sends the second configuration information to the first terminal device, where the second configuration information includes the first mapping relationship. Thus, the network device completes the determination of the first mapping relationship and sends it to the relay terminal device, which then configures the first mapping relationship for the first terminal device.

The present disclosure provides another relay communication configuration method. FIG. 14 is a schematic flowchart of another relay communication configuration method according to an embodiment of the present disclosure, which may be applied to a network device. This method may be executed independently, combined with any embodiment or implementation in the present disclosure, or combined with any technical solution in related art.

As shown in FIG. 14, the relay communication configuration method may include the following steps.
Step S1401: receiving first information sent by the relay terminal device, where the first information includes a pair of a source layer 2 address of the first terminal device and a source layer 2 address of the second terminal device, and/or identifier request information of the first terminal device, and/or identifier request information of the second terminal device. The first terminal device communicates with the second terminal device through the relay terminal device.

The relay terminal device reports the pair of the source layer 2 address of the first terminal device and the source layer 2 address of the second terminal device, and/or identifier request information of the first terminal device, and/or identifier request information of the second terminal device to the network device. The network device receives the source layer 2 addresses and/or identifier request information.

In the present disclosure, the first terminal device may communicate with the second terminal device through the relay terminal device. The first terminal device may be a source remote terminal device, and the second terminal device may be a target remote terminal device, or vice versa.
Step S1402: determining a first mapping relationship corresponding to an identifier of the first terminal device, where the first mapping relationship is a mapping relationship among an identifier of the second terminal device, a bearer identifier, and an outbound PC5 RLC channel.

The network device determines the first mapping relationship based on the source layer 2 address of the first terminal device and the source layer 2 address of the second terminal device and sends the first configuration information to the relay terminal device.

In the present disclosure, the first mapping relationship may include one or multiple identifiers of the second terminal device, and one identifier of the second terminal device may correspond to one or multiple bearer identifiers, which is not limited herein.

Optionally, the first mapping relationship may further be pre-configured.
Step S1403: sending first configuration information to the relay terminal device, where the first configuration information includes the first mapping relationship.

In this technical solution, the network device determines the first mapping relationship based on the first information, which includes the pair of the source layer 2 address of the first terminal device and the source layer 2 address of the second terminal device, and/or identifier request information of the first terminal device, and/or identifier request information of the second terminal device. The network device includes the first mapping relationship in the first configuration information and sends it to the relay terminal device. The relay terminal device determines the first mapping relationship upon receiving the first configuration information and sends the second configuration information to the first terminal device, where the second configuration information includes the first mapping relationship. Thus, the network device completes the determination of the first mapping relationship and sends it to the relay terminal device, which then configures the first mapping relationship for the first terminal device.

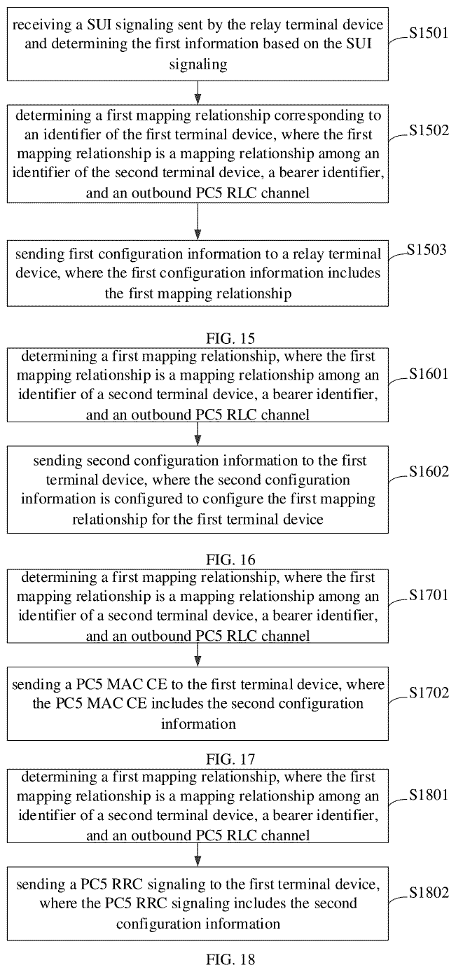

The present disclosure provides another relay communication configuration method. FIG. 15 is a schematic flowchart of another relay communication configuration method according to an embodiment of the present disclosure, which may be applied to a network device. This method may be executed independently, combined with any embodiment or implementation in the present disclosure, or combined with any technical solution in related art.

As shown in FIG. 15, the relay communication configuration method may include the following steps.
Step S1501: receiving a sidelink UE information (SUI) signaling sent by the relay terminal device and determining the first information based on the SUI signaling; or receiving a UE assistance information (UAI) signaling sent by the relay terminal device and determining the first information based on the UAI signaling.

The first information includes a pair of the source layer 2 address of the first terminal device and the source layer 2 address of the second terminal device, and/or identifier request information of the first terminal device, and/or identifier request information of the second terminal device. The first terminal device communicates with the second terminal device through the relay terminal device.

The SUI signaling and UAI signaling are configured to send the first information between the relay terminal device and the network device. The relay terminal device may report the first information via SUI or UAI signaling to assist the network device in configuring the first mapping relationship. The SUI signaling or UAI signaling may include one or more of the following: the pair of the source layer 2 address of the first terminal device and the source layer 2 address of the second terminal device, identifier request information of the first terminal device, or identifier request information of the second terminal device. The identifier of the first terminal device is associated with its source layer 2 address, and the identifier of the second terminal device is associated with its source layer 2 address. The content included in the SUI or UAI signaling is not limited herein.
Step S1502: determining a first mapping relationship corresponding to an identifier of the first terminal device, where the first mapping relationship is a mapping relationship among an identifier of the second terminal device, a bearer identifier, and an outbound PC5 RLC channel.

The first information included in SUI signaling or UAI signaling is reported to the network device by the relay terminal device. The network device reports the source layer 2 address contained in the first information of the SUI signaling or UAI signaling. The network device determines the first mapping relationship based on the source layer 2 address of the first terminal device and the source layer 2 address of the second terminal device.

In the present disclosure, the first mapping relationship may include one or multiple identifiers of the second terminal device, and one identifier of the second terminal device may correspond to one or multiple bearer identifiers, which is not limited herein.

Optionally, the first mapping relationship may further be pre-configured.
Step S1503: sending first configuration information to a relay terminal device, where the first configuration information includes the first mapping relationship.

In this technical solution, the network device parses the received SUI signaling or UAI signaling to obtain first information that includes a pair of source Layer 2 addresses of the first terminal device and the second terminal device. Based on the first information, the network device determines the first mapping relationship, carries the first mapping relationship in the first configuration information, and sends the first configuration information to the relay terminal device. After receiving the first configuration information, the relay terminal device determines the first mapping relationship and sends second configuration information to the first terminal device, where the second configuration information includes the first mapping relationship. Thus, the network device completes the determination of the first mapping relationship and sends it to the relay terminal device, which then configures the first mapping relationship for the first terminal device.

The embodiments of the present disclosure provide another relay communication configuration method. FIG. 16 is a schematic flowchart of another relay communication configuration method provided by the embodiments of the present disclosure, which can be applied to a relay terminal device. This relay communication configuration method can be executed independently, in combination with any embodiment or implementation in the present disclosure, or in combination with any technical solution in related technologies.

As shown in FIG. 16, the relay communication configuration method may include the following steps.
Step S1601: determining a first mapping relationship, where the first mapping relationship is a mapping relationship among an identifier of a second terminal device, a bearer identifier, and an outbound PC5 radio link control (RLC) channel.

In the present disclosure, the relay terminal device can determine the first mapping relationship by itself without needing to report the pair of source Layer 2 addresses of the first terminal device and the second terminal device to the network device via SUI. The first mapping relationship may be a mapping relationship among the identifier of the second terminal device, the bearer identifier, and the outbound PC5 RLC channel.

For example, the first mapping relationship may be in the form of a list, such as Table 1 below, which shows the first mapping relationship corresponding to a certain first terminal device.

TABLE 1

| | | |
|---|---|---|
| Second Terminal | Bearer C1 | Outbound PC5 RLC |
| Device B1 | | Channel 1 |
| Second Terminal | Bearer C2 | Outbound PC5 RLC |
| Device B1 | | Channel 2 |
| Second Terminal | Bearer C1 | Outbound PC5 RLC |
| Device B2 | | Channel 3 |
| . . . | . . . | . . . |

In Table 1, B1 and B2 represent identifiers of the second terminal devices, and C1, C2, and C3 represent bearer identifiers.

In the present disclosure, the first mapping relationship may include one or more identifiers of the second terminal device, and one identifier of the second terminal device may correspond to one or more bearer identifiers. The present disclosure does not limit this.
Step S1602: sending second configuration information to the first terminal device, where the second configuration information is configured to configure the first mapping relationship for the first terminal device.

The first terminal device communicates with the second terminal device through the relay terminal device.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. The relay terminal device may then send the corresponding first mapping relationship to the first terminal device a and the first terminal device b. Both the first terminal device a and b can communicate with other terminal devices through the relay terminal device.

In the present disclosure, the first terminal device can communicate with the second terminal device through the relay terminal device. The first terminal device may be a source remote terminal device, and the second terminal device may be a target remote terminal device, or the second terminal device may be a source remote terminal device, and the first terminal device may be a target remote terminal device.

In this technical solution, the relay terminal device determines the first mapping relationship and directly sends the second configuration information to the first terminal device to configure the first mapping relationship for the first terminal device. Thus, the relay terminal device completes the determination of the first mapping relationship and also configures the first mapping relationship for the first terminal device.

The embodiments of the present disclosure provide another relay communication configuration method. FIG. 17 is a schematic flowchart of another relay communication configuration method provided by the embodiments of the present disclosure, which can be applied to a relay terminal device. This relay communication configuration method can be executed independently, in combination with any embodiment or implementation in the present disclosure, or in combination with any technical solution in related technologies.

As shown in FIG. 17, the relay communication configuration method may include the following steps.
Step S1701: determining a first mapping relationship, where the first mapping relationship is a mapping relationship among an identifier of a second terminal device, a bearer identifier, and an outbound PC5 radio link control (RLC) channel.

In the present disclosure, the relay terminal device can determine the first mapping relationship by itself without needing to report the pair of source Layer 2 addresses of the first terminal device and the second terminal device to the network device via SUI, and/or identifier request information of the first terminal device, and/or identifier request information of the second terminal device. The first mapping relationship may be a mapping relationship among the identifier of the second terminal device, the bearer identifier, and the outbound PC5 RLC channel.

In the present disclosure, the first mapping relationship may include one or more identifiers of the second terminal device, and one identifier of the second terminal device may correspond to one or more bearer identifiers. The present disclosure does not limit this.
Step S1702: sending a PC5 media access control control element (MAC CE) to the first terminal device, where the PC5 MAC CE includes the second configuration information.

In the present disclosure, the relay terminal device may send a media access control control element (MAC CE) to the first terminal device, where the PC5 MAC CE includes the first configuration information. That is, the relay terminal device can configure the first mapping relationship for the first terminal device through the PC5 MAC CE.

The first terminal device may receive the PC5 MAC CE sent by the relay terminal device, where the PC5 MAC CE includes the first configuration information. The first terminal device can then determine the first configuration information based on the PC5 MAC CE.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. The relay terminal device may then send the corresponding first mapping relationship to the first terminal device a and the first terminal device b. Both the first terminal device a and b can communicate with other terminal devices through the relay terminal device.

In the present disclosure, the first terminal device can communicate with the second terminal device through the relay terminal device. The first terminal device may be a source remote terminal device, and the second terminal device may be a target remote terminal device, or vice versa.

In this technical solution, the relay terminal device determines the first mapping relationship and directly sends the second configuration information included in the MAC CE to the first terminal device to configure the first mapping relationship for the first terminal device. Thus, the relay terminal device completes the determination of the first mapping relationship and also configures the first mapping relationship for the first terminal device.

The embodiments of the present disclosure provide another relay communication configuration method. FIG. 18 is a schematic flowchart of another relay communication configuration method provided by the embodiments of the present disclosure, which can be applied to a relay terminal device. This relay communication configuration method can be executed independently, in combination with any embodiment or implementation in the present disclosure, or in combination with any technical solution in related technologies.

As shown in FIG. 18, the relay communication configuration method may include the following steps.
Step S1801: determining a first mapping relationship, where the first mapping relationship is a mapping relationship among an identifier of a second terminal device, a bearer identifier, and an outbound PC5 radio link control (RLC) channel.

In the present disclosure, the relay terminal device can determine the first mapping relationship by itself without needing to report the pair of source Layer 2 addresses of the first terminal device and the second terminal device to the network device via SUI, and/or identifier request information of the first terminal device, and/or identifier request information of the second terminal device. The first mapping relationship may be a mapping relationship among the identifier of the second terminal device, the bearer identifier, and the outbound PC5 RLC channel.

In the present disclosure, the first mapping relationship may include one or more identifiers of the second terminal device, and one identifier of the second terminal device may correspond to one or more bearer identifiers. The present disclosure does not limit this.
Step S1802: sending a PC5 radio resource control (RRC) signaling to the first terminal device, where the PC5 RRC signaling includes the second configuration information.

In the present disclosure, the relay terminal device may further send PC5-RRC signaling to the first terminal device, where the PC5-RRC signaling includes the first configuration information. The PC5-RRC signaling may be RRCReconfigurationSidelink signaling or other PC5-RRC signaling, which is not limited in the present disclosure. That is, the relay terminal device can configure the first mapping relationship for the first terminal device through PC5-RRC signaling. Alternatively, the relay terminal device can configure the first mapping relationship for the first terminal device through PC5 MAC CE, which is not limited in the present disclosure.

Optionally, if there are multiple first terminal devices, the relay terminal device may configure the corresponding first mapping relationship for each first terminal device.

For example, the relay terminal device determines the second configuration information corresponding to the first terminal device a, so as to configure the first mapping relationship for the first terminal device, and determines the second configuration information corresponding to the first terminal device b, so as to configure the first mapping relationship for the first terminal device. The relay terminal device may then send the corresponding first mapping relationship to the first terminal device a and the first terminal device b. Both the first terminal device a and b can communicate with other terminal devices through the relay terminal device.

In the present disclosure, the first terminal device can communicate with the second terminal device through the relay terminal device. The first terminal device may be a source remote terminal device, and the second terminal device may be a target remote terminal device, or vice versa.

In this technical solution, the relay terminal device determines the first mapping relationship and directly sends the second configuration information included in the PC5-RRC signaling to the first terminal device to configure the first mapping relationship for the first terminal device. Thus, the relay terminal device completes the determination of the first mapping relationship and also configures the first mapping relationship for the first terminal device.

From the above embodiments, it can be seen that the first mapping relationship can be determined by the network device or by the relay terminal device. One implementation is: when the relay terminal device is outside the coverage of the network device, the relay terminal device determines the first mapping relationship; when the relay terminal device is within the coverage of the network device, the network device determines the first mapping relationship.

When the relay terminal device is in the RRC connected state, the relay terminal device reports the first information to the network device via SUI signaling or UAI signaling, where the first information includes the pair of source Layer 2 addresses of the first terminal device and the second terminal device, and/or identifier request information of the first terminal device, and/or identifier request information of the second terminal device. The network device determines the first mapping relationship based on the first information.

When the relay terminal device is in the RRC non-connected state, and the relay terminal device determines that the end-to-end connection establishment between the first terminal device and the second terminal device is completed, the relay terminal device triggers the transition to the RRC connected state. The relay terminal device in the RRC connected state reports the first information to the network device via SUI signaling or UAI signaling, where the first information includes the pair of source Layer 2 addresses of the first terminal device and the second terminal device, and/or identifier request information of the first terminal device, and/or identifier request information of the second terminal device. The network device determines the first mapping relationship based on the first information.

Another implementation is: regardless of whether the relay terminal device is within or outside the coverage of the network device, the relay terminal device determines the first mapping relationship. In this solution, the relay terminal device does not need to report the first information to the network device via SUI signaling or UAI signaling.

Another implementation is: when the relay terminal device is in the RRC non-connected state, the relay terminal device determines the first mapping relationship; when the relay terminal device is in the RRC connected state, the relay terminal device reports the first information to the network device via SUI signaling or UAI signaling, where the first information includes the pair of source Layer 2 addresses of the first terminal device and the second terminal device, and/or identifier request information of the first terminal device, and/or identifier request information of the second terminal device. The network device determines the first mapping relationship based on the first information. In this solution, when the relay terminal device in the RRC non-connected state determines that the end-to-end connection establishment between the first terminal device and the second terminal device is completed, it does not need to trigger the transition to the RRC connected state and the report of the first information, but instead, the relay terminal device determines the first mapping relationship by itself.

Corresponding to the relay communication configuration method provided in the embodiments of FIGS. 2 to 11, the present disclosure also provides a relay communication configuration apparatus. Since the relay communication configuration apparatus provided in the embodiments of the present disclosure corresponds to the relay communication configuration method provided in the embodiments of FIGS. 2 to 11, the implementation of the relay communication configuration method is also applicable to the relay communication configuration apparatus provided in the embodiments of the present disclosure, and will not be described in detail in the embodiments of the present disclosure.

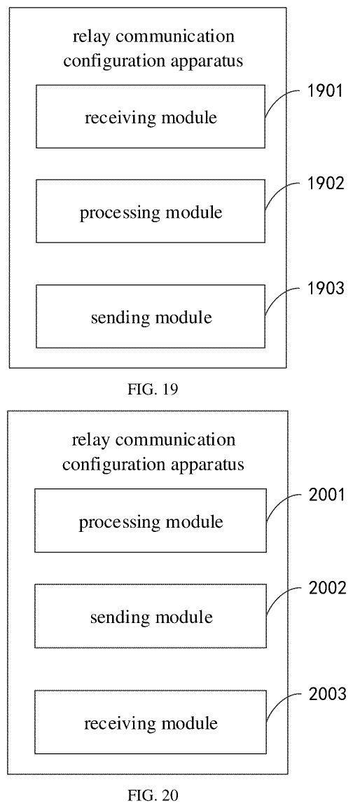

FIG. 19 is a schematic structural diagram of a relay communication configuration apparatus provided by the embodiments of the present disclosure. The apparatus is applied to a relay terminal device and includes:
a receiving module 1901 configured to receive first configuration information sent by a network device;
a processing module 1902 configured to determine a first mapping relationship based on the first configuration information, where the first mapping relationship is a mapping relationship among an identifier of a second terminal device, a bearer identifier, and an outbound PC5 radio link control (RLC) channel;
a sending module 1903 configured to send second configuration information to a first terminal device, where the second configuration information is configured to configure the first mapping relationship for the first terminal device, and the first terminal device communicates with the second terminal device through the relay terminal device.

The sending module 1903 is further configured to:
send a PC5 media access control control element (MAC CE) to the first terminal device, where the PC5 MAC CE includes the second configuration information.

The sending module 1903 is further configured to:
send a PC5 radio resource control (RRC) signaling to the first terminal device, where the PC5 RRC signaling includes the second configuration information.

The receiving module 1901 is further configured to:
receive a dedicated radio resource control (RRC) signaling sent by the network device;
determine the first configuration information based on the dedicated RRC signaling.

The receiving module 1901 is further configured to:
receive system information block (SIB) information sent by the network device;
determine the first configuration information based on the SIB information.

The sending module 1903 is further configured to:
send first information to the network device, where the first information includes a pair of source Layer 2 addresses of the first terminal device and the second terminal device, and the first terminal device communicates with the second terminal device through the relay terminal device.

The sending module 1903 is further configured to:
send the first information to the network device in response to the relay terminal device being in the RRC connected state.

The sending module 1903 is further configured to:
send the first information to the network device in response to the relay terminal device transitioning from the RRC idle state or the RRC inactive state to the RRC connected state.

The sending module 1903 is further configured to:
send a sidelink UE information (SUI) signaling to the network device, where the SUI signaling includes the first information.

The sending module 1903 is further configured to:
send UE assistance information (UAI) signaling to the network device, where the UAI signaling includes the first information.

The SUI signaling or the UAI signaling includes one or more of the following:
the pair of source Layer 2 addresses of the first terminal device and the second terminal device;
identifier request information of the first terminal device; or
identifier request information of the second terminal device.

The identifier of the first terminal device is associated with the source Layer 2 address of the first terminal device, and the identifier of the second terminal device is associated with the source Layer 2 address of the second terminal device.

The processing module 1902 is further configured to:
trigger the relay terminal device to transition from the RRC idle state or the RRC inactive state to the RRC connected state in response to determining that the end-to-end PC5 connection establishment between the first terminal device and the second terminal device is completed.

The processing module 1902 is further configured to:
determine that the end-to-end PC5 connection establishment between the first terminal device and the second terminal device is completed in response to the relay terminal device receiving a direct communication request (DCR) message which is transmitted by the first terminal device through a specified PC5-RLC channel and the relay terminal device receiving a direct communication acceptance (DCA) message which is transmitted by the second terminal device through a specified PC5-RLC channel.

Corresponding to the relay communication configuration method provided in the embodiments of FIGS. 12 to 15, the present disclosure also provides a relay communication configuration apparatus. Since the relay communication configuration apparatus provided in the embodiments of the present disclosure corresponds to the relay communication configuration method provided in the embodiments of FIGS. 12 to 15, the implementation of the relay communication configuration method is also applicable to the relay communication configuration apparatus provided in the embodiments of the present disclosure, and will not be described in detail in the embodiments of the present disclosure.

FIG. 20 is a schematic structural diagram of a relay communication configuration apparatus provided by the embodiments of the present disclosure. The apparatus is applied to a network device and includes:
a processing module 2001 configured to determine a first mapping relationship corresponding to an identifier of a first terminal device, where the first mapping relationship is a mapping relationship among an identifier of a second terminal device, a bearer identifier, and an outbound PC5 radio link control (RLC) channel;
a sending module 2002 configured to send first configuration information to a relay terminal device, where the first configuration information includes the first mapping relationship.

In this technical solution, the network device determines the first mapping relationship, carries it in the first configuration information, and sends the first configuration information to the relay terminal device. The relay terminal device, after receiving the first configuration information, configures the first mapping relationship for the first terminal device. Thus, the network device completes the determination of the first mapping relationship and sends it to the relay terminal device, which then configures the first mapping relationship for the first terminal device.

In an implementation, the sending module 2002 is further configured to:
send a dedicated radio resource control (RRC) signaling to the relay terminal device, where the dedicated RRC signaling includes the first configuration information.

In an implementation, the sending module 2002 is further configured to:
send system information block (SIB) information to the relay terminal device, where the SIB information includes the first configuration information.

In an implementation, the apparatus further includes:
a receiving module 2003, configured to receive first information sent by the relay terminal device, where the first information includes a pair of source Layer 2 addresses of the first terminal device and the second terminal device, and/or identifier request information of the first terminal device, and/or identifier request information of the second terminal device. The first terminal device communicates with the second terminal device through the relay terminal device.

In an implementation, the receiving module 2003 is further configured to:
receive a sidelink UE information (SUI) signaling sent by the relay terminal device;
determine the first information based on the SUI signaling.

In an implementation, the receiving module 2003 is further configured to:
receive UE assistance information (UAI) signaling sent by the relay terminal device;
determine the first information based on the UAI signaling.

In an implementation, the SUI signaling or the UAI signaling includes one or more of the following:
the pair of source Layer 2 addresses of the first terminal device and the second terminal device;
identifier request information of the first terminal device;
identifier request information of the second terminal device.

In an implementation, the identifier of the first terminal device is associated with the source Layer 2 address of the first terminal device, and the identifier of the second terminal device is associated with the source Layer 2 address of the second terminal device.

Corresponding to the relay communication configuration method provided in the embodiments of FIGS. 16 to 18, the present disclosure also provides a relay communication configuration apparatus. Since the relay communication configuration apparatus provided in the embodiments of the present disclosure corresponds to the relay communication configuration method provided in the embodiments of FIGS. 16 to 18, the implementation of the relay communication configuration method is also applicable to the relay communication configuration apparatus provided in the embodiments of the present disclosure, and will not be described in detail in the embodiments of the present disclosure.

FIG. 21 is a schematic structural diagram of a relay communication configuration apparatus provided by the embodiments of the present disclosure. The apparatus is applied to FIGS. 16 to 18 and includes:
a processing module 2101 configured to determine a first mapping relationship, where the first mapping relationship is a mapping relationship among an identifier of a second terminal device, a bearer identifier, and an outbound PC5 radio link control (RLC) channel;
a sending module 2102 configured to send second configuration information to a first terminal device, where the second configuration information is configured to configure the first mapping relationship for the first terminal device.

In this technical solution, the relay terminal device determines the first mapping relationship and directly sends the second configuration information to the first terminal device to configure the first mapping relationship for the first terminal device. Thus, the relay terminal device completes the determination of the first mapping relationship and also configures the first mapping relationship for the first terminal device.

In an implementation, the sending module 2102 is further configured to:
send a PC5 media access control control element (MAC CE) to the first terminal device, where the PC5 MAC CE includes the second configuration information.

In an implementation, the sending module 2102 is further configured to:
send a PC5 radio resource control (RRC) signaling to the first terminal device, where the PC5 RRC signaling includes the second configuration information.

In an implementation, the processing module 2101 is further configured to:
determine the first mapping relationship in response to the relay terminal device being in the non-RRC connected state.

In an implementation, the processing module 2101 is further configured to:
determine the first mapping relationship in response to the relay terminal device being outside a coverage of a network device.

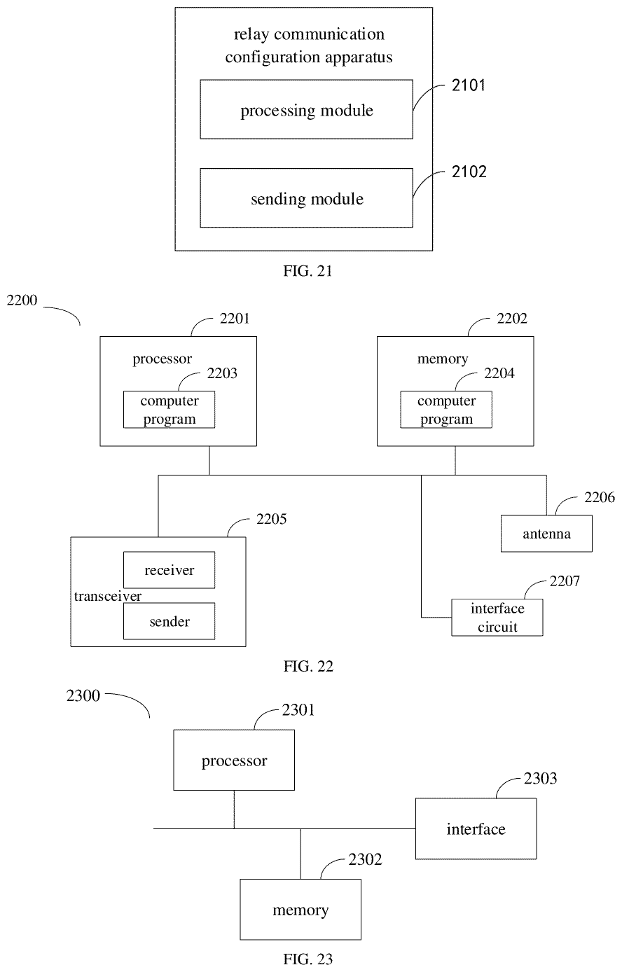

Please refer to FIG. 22, which is a schematic structural diagram of another communication apparatus provided by the embodiments of the present disclosure. In FIG. 22, the communication apparatus 2200 may be a network device, a relay terminal device, a chip, a chip system, or a processor that supports the network device in implementing the above methods, or a chip, a chip system, or a processor that supports the terminal device in implementing the above methods. The apparatus can be used to implement the methods described in the above method embodiments, and specific details can be found in the descriptions of the above method embodiments.

The communication apparatus 2200 may include one or more processors 2201. The processor 2201 may be a general-purpose processor or a special-purpose processor, such as a baseband processor or a central processing unit (CPU). The baseband processor may be used to process communication protocols and communication data, and the CPU may be used to control the communication apparatus (e.g., a base station, a baseband chip, a terminal device, a terminal device chip, a DU, or a CU), execute computer programs, and process data of the computer programs.

Optionally, the communication apparatus 2200 may further include one or more memories 2202, on which a computer program 2204 may be stored. The processor 2201 executes the computer program 2204 to enable the communication apparatus 2200 to perform the methods described in the above method embodiments. Optionally, the memory 2202 may further store data. The communication apparatus 2200 and the memory 2202 may be set separately or integrated together.

Optionally, the communication apparatus 2200 may further include a transceiver 2205 and an antenna 2206. The transceiver 2205 may be referred to as a transceiver unit, a transceiver machine, or a transceiver circuit, and is used to implement transceiver functions. The transceiver 2205 may include a receiver and a transmitter. The receiver may be referred to as a receiver machine or a receiver circuit, and is used to implement receiving functions. The transmitter may be referred to as a transmitter machine or a transmitter circuit, and is used to implement transmitting functions.

Optionally, the communication apparatus 2200 may further include one or more interface circuits 2207. The interface circuit 2207 is used to receive code instructions and transmit them to the processor 2201. The processor 2201 executes the code instructions to enable the communication apparatus 2200 to perform the methods described in the above method embodiments.

When the communication apparatus 2200 is a relay terminal device: the processor 2201 is used to execute step S202 in FIG. 2, step S302 in FIG. 3, step S402 in FIG. 4, step S503 in FIG. 5, etc.

When the communication apparatus 2200 is a network device: the transceiver 2205 is used to execute step S1202 in FIG. 12, etc.

In one implementation, the processor 2201 may include a transceiver for implementing receiving and transmitting functions. For example, the transceiver may be a transceiver circuit, an interface, or an interface circuit. The transceiver circuit, interface, or interface circuit for implementing receiving and transmitting functions may be separate or integrated. The transceiver circuit, interface, or interface circuit may be used for reading/writing code/data or for transmitting/passing signals.

In one implementation, the processor 2201 may store a computer program 2203. The computer program 2203 runs on the processor 2201 to enable the communication apparatus 2200 to perform the methods described in the above method embodiments. The computer program 2203 may be solidified in the processor 2201, in which case the processor 2201 may be implemented by hardware.

In one implementation, the communication apparatus 2200 may include a circuit that implements the functions of transmitting, receiving, or communicating as described in the foregoing method embodiments. The processor and transceiver described in the present disclosure may be implemented in an integrated circuit (IC), an analog IC, a radio frequency integrated circuit (RFIC), a mixed-signal IC, an application-specific integrated circuit (ASIC), a printed circuit board (PCB), an electronic device, etc. The processor and transceiver may further be manufactured using various IC process technologies, such as complementary metal-oxide-semiconductor (CMOS), N-type metal-oxide-semiconductor (NMOS), P-type metal-oxide-semiconductor (PMOS), bipolar junction transistor (BJT), bipolar CMOS (BiCMOS), silicon germanium (SiGe), gallium arsenide (GaAs), etc.

The communication apparatus described in the above embodiments may be a network device or a terminal device, but the scope of the communication apparatus described in the present disclosure is not limited to this, and the structure of the communication apparatus is not limited by FIG. 22. The communication apparatus may be an independent device or part of a larger device. For example, the communication apparatus may be:
(1) an independent integrated circuit (IC), chip, chip system, or subsystem;
(2) a collection of one or more ICs, optionally, the IC collection may further include storage components for storing data and computer programs;
(3) an ASIC, such as a modem (Modem);
(4) a module embedded in other devices;
(5) a receiver, terminal device, smart terminal device, cellular phone, wireless device, handset, mobile unit, vehicle-mounted device, network device, cloud device, artificial intelligence device, etc.;
(6) Others, etc.

For the case where the communication apparatus is a chip or chip system, please refer to the schematic structural diagram of the chip shown in FIG. 23. The chip 2300 shown in FIG. 23 includes a processor 2301 and an interface 2303. The number of processors 2301 may be one or more, and the number of interfaces 2303 may be multiple.

For the case where the chip is used to implement the functions of the relay terminal device in the embodiments of the present disclosure:
the interface 2303 is used to execute step S201 in FIG. 12; step S301 in FIG. 3; step S401 in FIG. 4; step S501 in FIG. 5, etc.

For the case where the chip is used to implement the functions of the network device in the embodiments of the present disclosure:
the interface 2303 is used to execute step S1202 in FIG. 12, etc.

For the case where the chip is used to implement the functions of the relay terminal device in the embodiments of the present disclosure:
the interface 2303 is used to execute step S1602 in FIG. 16, etc.

Optionally, the chip 2300 further includes a memory 1202, where the memory 2302 is used to store necessary computer programs and data.

Those skilled in the art can also understand that the various illustrative logical blocks (illustrative logical blocks) and steps (steps) listed in the embodiments of the present disclosure can be implemented through electronic hardware, computer software, or a combination of both. Whether such functions are implemented through hardware or software depends on the specific application and design constraints of the entire system. Those skilled in the art can use various methods to implement the described functions for each specific application, but such implementation should not be understood as going beyond the scope of protection of the embodiments of the present disclosure.

The present disclosure also provides a readable storage medium on which instructions are stored. When the instructions are executed by a computer, the functions of any of the above method embodiments are implemented.

The present disclosure also provides a computer program product. When the computer program product is executed by a computer, the functions of any of the above method embodiments are implemented.

In the above embodiments, the functions may be implemented entirely or partially through software, hardware, firmware, or any combination thereof. When implemented through software, the functions may be implemented entirely or partially in the form of a computer program product. The computer program product includes one or more computer programs. When the computer programs are loaded and executed on a computer, the processes or functions described in the embodiments of the present disclosure are generated entirely or partially. The computer may be a general-purpose computer, a special-purpose computer, a computer network, or other programmable devices. The computer programs may be stored in a computer-readable storage medium or transmitted from one computer-readable storage medium to another computer-readable storage medium. For example, the computer programs may be transmitted from a website, computer, server, or data center to another website, computer, server, or data center through wired (e.g., coaxial cable, optical fiber, digital subscriber line (DSL)) or wireless (e.g., infrared, wireless, microwave, etc.) means. The computer-readable storage medium may be any available medium that can be accessed by a computer or a data storage device such as a server or data center integrated with one or more available media. The available medium may be a magnetic medium (e.g., floppy disk, hard disk, magnetic tape), an optical medium (e.g., high-density digital video disc (DVD)), or a semiconductor medium (e.g., solid-state disk (SSD)), etc.

Those of ordinary skill in the art can understand that the first, second, and other numerical references involved in the present disclosure are only used for distinguishing descriptions and do not limit the scope of the embodiments of the present disclosure, nor do they indicate a sequence.

In the present disclosure, “at least one” may further be described as “one or more”, and “multiple” may be two, three, four, or more, which is not limited in the present disclosure. In the embodiments of the present disclosure, for a technical feature, the technical features are distinguished by “first”, “second”, “third”, “A”, “B”, “C”, and “D”, etc. The technical features described by “first”, “second”, “third”, “A”, “B”, “C”, and “D” have no sequence or size order.

The corresponding relationships shown in the tables in the present disclosure may be configured or predefined. The values of the information in the tables are only examples and may be configured as other values, which is not limited in the present disclosure. When configuring the corresponding relationships between configuration information and parameters, it is not necessary to configure all the corresponding relationships shown in the tables. For example, in the tables of the present disclosure, some rows of corresponding relationships may not be configured. Alternatively, the tables may be appropriately modified, such as splitting, merging, etc. The parameter names shown in the titles of the tables may further be other names understandable by the communication apparatus, and the parameter values or representation methods may further be other values or representation methods understandable by the communication apparatus. The tables may further be implemented using other data structures, such as arrays, queues, containers, stacks, linear lists, pointers, linked lists, trees, graphs, structures, classes, heaps, hash tables, etc.

1. A relay communication configuration method, performed by a relay terminal device, comprising:
receiving first configuration information sent by a network device;
determining a first mapping relationship based on the first configuration information, wherein the first mapping relationship is a mapping relationship among an identifier of a second terminal device, a bearer identifier, and an outbound PC5 radio link control (RLC) channel; and
sending second configuration information to a first terminal device, wherein the second configuration information is configured to configure the first mapping relationship for the first terminal device, wherein the first terminal device communicates with the second terminal device through the relay terminal device.

2. The method according to claim 1, wherein sending the second configuration information to the first terminal device comprises:
sending a PC5 media access control control element (MAC CE) to the first terminal device, wherein the PC5 MAC CE comprises the second configuration information; or
sending a PC5 radio resource control (RRC) signaling to the first terminal device, wherein the PC5 RRC signaling comprises the second configuration information.

3. The method according to claim 1, wherein receiving the first configuration information sent by the network device comprises:
receiving a dedicated RRC signaling sent by the network device, and determining the first configuration information based on the dedicated RRC signaling; or
receiving system information block (SIB) information sent by the network device, and determining the first configuration information based on the SIB information.

4. The method according to claim 1, further comprising:
sending first information to the network device, wherein the first information comprises a pair of a source layer 2 address of the first terminal device and a source layer 2 address of the second terminal device, wherein the first terminal device communicates with the second terminal device through the relay terminal device.

5. The method according to claim 4, wherein sending the first information to the network device comprises:
in response to the relay terminal device being in an RRC connected state, sending the first information to the network device; or
in response to the relay terminal device transitioning from an RRC idle state or an RRC inactive state to the RRC connected state, sending the first information to the network device.

6. (canceled)

7. The method according to claim 5, wherein sending the first information to the network device comprises:
sending a sidelink UE information (SUI) signaling to the network device, wherein the SUI signaling comprises the first information; or
sending a UE assistance information (UAI) signaling to the network device, wherein the UAI signaling comprises the first information.

8. The method according to claim 7, wherein the SUI signaling or the UAI signaling comprises one or more of:
the pair of the source layer 2 address of the first terminal device and the source layer 2 address of the second terminal device;
identifier request information of the first terminal device; or
identifier request information of the second terminal device,
wherein an identifier of the first terminal device is associated with the source layer 2 address of the first terminal device, and the identifier of the second terminal device is associated with the source layer 2 address of the second terminal device.

9. (canceled)

10. The method according to claim 5, wherein the relay terminal device transitioning from the RRC idle state or the RRC inactive state to the RRC connected state comprises:
in response to determining that an establishment of an end-to-end PC5 connection between the first terminal device and the second terminal device is completed, triggering the relay terminal device to transition from the RRC idle state or the RRC inactive state to the RRC connected state.

11. The method according to claim 10, wherein determining that the establishment of the end-to-end PC5 connection between the first terminal device and the second terminal device is completed comprises:
in response to the relay terminal device receiving a direct communication request (DCR) message transmitted by the first terminal device through a specified PC5-RLC channel and the relay terminal device receiving a direct communication acceptance (DCA) message transmitted by the second terminal device through a specified PC5-RLC channel, determining that the establishment of the end-to-end PC5 connection between the first terminal device and the second terminal device is completed.

12. A relay communication configuration method, performed by a network device, comprising:
determining a first mapping relationship corresponding to an identifier of a first terminal device, wherein the first mapping relationship is a mapping relationship among an identifier of a second terminal device, a bearer identifier, and an outbound PC5 RLC channel; and
sending first configuration information to a relay terminal device, wherein the first configuration information comprises the first mapping relationship.

13. The method according to claim 12, wherein sending the first configuration information to the relay terminal device comprises:
sending a dedicated RRC signaling to the relay terminal device, wherein the dedicated RRC signaling comprises the first configuration information; or
sending SIB information to the relay terminal device, wherein the SIB information comprises the first configuration information.

14. The method according to claim 12, further comprising:
receiving first information sent by the relay terminal device, wherein the first information comprises a pair of a source layer 2 address of the first terminal device and a source layer 2 address of the second terminal device, and the first terminal device communicates with the second terminal device through the relay terminal device.

15. The method according to claim 14, wherein receiving the first information sent by the relay terminal device comprises:
receiving a SUI signaling sent by the relay terminal device, and determining the first information based on the SUI signaling; or
receiving a UAI signaling sent by the relay terminal device, and determining the first information based on the UAI signaling.

16. (canceled)

17. (canceled)

18. A relay communication configuration method, performed by a relay terminal device, comprising:
determining a first mapping relationship, wherein the first mapping relationship is a mapping relationship among an identifier of a second terminal device, a bearer identifier, and an outbound PC5 RLC channel; and
sending second configuration information to a first terminal device, wherein the second configuration information is configured to configure the first mapping relationship for the first terminal device.

19. The method according to claim 18, wherein sending the second configuration information to the first terminal device comprises:
sending a PC5 MAC CE to the first terminal device, wherein the PC5 MAC CE comprises the second configuration information; or
sending a PC5 RRC signaling to the first terminal device, wherein the PC5 RRC signaling comprises the second configuration information.

20. The method according to claim 18, wherein determining the first mapping relationship comprises:
in response to the relay terminal device being in a non-RRC connected state, determining the first mapping relationship; or
in response to the relay terminal device being outside a coverage of a network device, determining the first mapping relationship.

21.-24. (canceled)

25. A communication apparatus, comprising:
a processor; and
a memory storing a computer program executable by the processor;
wherein the processor is configured to perform the method according to claim 1.

26. A non-transitory computer-readable storage medium having stored therein an instruction that, when executed by a processor, causes the processor to perform the method according to claim 1.

27. A communication apparatus, comprising:
a processor; and
a memory storing a computer program executable by the processor;
wherein the processor is configured to perform the method according to claim 12.

28. A non-transitory computer-readable storage medium having stored therein an instruction that, when executed by a processor, causes the processor to perform the method according to claim 12.
